(19) United States
(12) Patent Application Publication
(10) Pub. No.: US 2023/0111810 A1
(43) Pub. Date: Apr. 13, 2023

(54) METHOD AND DEVICE FOR MANAGING CLUSTER

(71) Applicant: LG ELECTRONICS INC., Seoul (KR)

(72) Inventors: Myoungseob KIM, Seoul (KR); Jaeho HWANG, Seoul (KR)

(73) Assignee: LG ELECTRONICS INC., Seoul (KR)

(21) Appl. No.: 17/906,114

(22) PCT Filed: Mar. 20, 2020
(86) PCT No.: PCT/KR2020/003893

§ 371 Date: Sep. 12, 2022

(51) Int. Cl. H04W 4/08; H04W 4/46; H04W 4/02; H04B 17/318

(52) U.S. Cl. CPC H04W 4/08; H04W 4/46; H04W 4/027; H04B 17/318

(57) ABSTRACT

Described in the present disclosure is a method for registering a cluster in advance between known VRUs, which are composed of relationships between protectors and protectees, and maintaining the VRU cluster in a state of movement of the cluster. In addition, proposed are a method for generating a cluster in various states of mobility amongst members, and a method in which VRUs maintain a cluster and update cluster information on the basis of received information while in a state of movement. In addition, proposed is a method in which, when some VRUs are unable to maintain a cluster, information about VRU deviation is sensed within the cluster or shared with the outside to prevent accidents.

### BACKGROUND OF THE DISCLOSURE

### Field of the Disclosure

The present disclosure relates to wireless communication.

### Related Art

V2X means communication between a terminal installed in a vehicle and other terminals, and the other terminals may be a pedestrian, a vehicle, and an infrastructure, and in this case, the other terminals may be sequentially called vehicle to pedestrian (V2P), vehicle to vehicle (V2V), vehicle to infrastructure (V2I), etc.

In V2X communication, data/control information may be transmitted and received through a sidelink defined in a D2D operation other than an uplink/downlink between a base station and the terminal used in conventional LTE communication.

### SUMMARY

The present disclosure describes a method of pre-registering between known VRUs configured in a relationship between a guardian and a person in need of protection to maintain the cluster in a moving state of the corresponding VRU cluster. In addition, the present specification proposes for a method to create a cluster in various mobility situations between members, a method in which VRUs maintain a cluster and update cluster information based on previously received information in a situation where VRUs are moving. In addition, when some VRUs fail to maintain a cluster, a method for preventing an accident by detecting VRU departure information within the cluster or sharing it with the outside is proposed.

According to the present disclosure, it is possible to manage a cluster composed of vulnerable road users, specifically, to more effectively protect vulnerable road users with weak cognitive functions in the cluster.

An effect which can be obtained through one specific example of the present disclosure is not limited to effects listed above. For example, there can be various technical effects which a person having ordinary skill in the related art can appreciate and derive from the present disclosure. As a result, the specific effect of the present disclosure is not limited to an effect explicitly disclosed in the present disclosure, but may include various effects which can be appreciated or derived from a technical feature of the present disclosure.

### BRIEF DESCRIPTION OF THE DRAWINGS

FIG. 1 shows a structure of an LTE system, in accordance with an embodiment of the present disclosure.

FIG. 2 shows a radio protocol architecture of a user plane, in accordance with an embodiment of the present disclosure.

FIG. 3 shows a radio protocol architecture of a control plane, in accordance with an embodiment of the present disclosure.

FIG. 4 shows a structure of an NR system, in accordance with an embodiment of the present disclosure.

FIG. 5 shows a functional division between an NG-RAN and a 5GC, in accordance with an embodiment of the present disclosure.

FIG. 6 shows a structure of a radio frame of an NR, in accordance with an embodiment of the present disclosure.

FIG. 7 shows a structure of a slot of an NR frame, in accordance with an embodiment of the present disclosure.

FIG. 8 shows a BWP based on an embodiment of the present disclosure.

FIG. 9 shows a radio protocol architecture for a SL communication, in accordance with an embodiment of the present disclosure.

FIG. 10 shows a radio protocol architecture for a SL communication, in accordance with an embodiment of the present disclosure.

FIG. 11 shows a UE performing V2X or SL communication in accordance with an embodiment of the present disclosure.

FIG. 12 shows a resource unit for V2X or SL communication based on an embodiment of the present disclosure.

FIG. 13 shows exemplary UE operations according to a transmission mode (TM) related to V2X/D2D in accordance with an embodiment of the present disclosure.

FIG. 14 shows an example of a selection of transmission resources in accordance with an embodiment of the present disclosure.

FIG. 15 is for explaining a cluster.

FIG. 16 schematically shows examples of constituting a cluster.

FIG. 17 schematically illustrates an example of clustering and cluster departure detection.

FIG. 18 schematically illustrates an example of a configuration of a PSM message according to some implementations of the present disclosure.

FIG. 19 schematically illustrates another example of a configuration of a PSM message according to some implementations of the present disclosure.

FIG. 20 is a flowchart of an example of a method for detecting an out-of-cluster VRU according to some implementations of the present disclosure.

FIG. 21 is a flowchart of an example of a clustering state change in accordance with some implementations of the present disclosure.

FIG. 22 is a flowchart of a method for managing a cluster of a first terminal according to some implementations of the present disclosure.

FIG. 23 shows a communication system (1), in accordance with an embodiment of the present disclosure.

FIG. 24 shows wireless devices, in accordance with an embodiment of the present disclosure.

FIG. 25 shows a signal process circuit for a transmission signal, in accordance with an embodiment of the present disclosure.

FIG. 26 shows another example of a wireless device, in accordance with an embodiment of the present disclosure.

FIG. 27 shows a hand-held device, in accordance with an embodiment of the present disclosure.

FIG. 28 shows a vehicle or an autonomous vehicle, in accordance with an embodiment of the present disclosure.

FIG. 29 shows a vehicle, in accordance with an embodiment of the present disclosure.

FIG. 30 shows an XR device, in accordance with an embodiment of the present disclosure.

FIG. 31 shows a robot, in accordance with an embodiment of the present disclosure.

FIG. 32 shows an AI device, in accordance with an embodiment of the present disclosure.

### DESCRIPTION OF EXEMPLARY EMBODIMENTS

In the present disclosure, “A or B” may mean “only A”, “only B” or “both A and B”. When expressed separately, “A or B” may be interpreted as “A and/or B” in the present disclosure. For example, in the present disclosure, “A, B or C” may mean “only A”, “only B”, “only C”, or “any combination of A, B and C”.

A slash (/) or a comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B” or “both A and B”. Also, in the present disclosure, the expression “at least one of A or B” or “at least one of A and/or B” may be interpreted the same as “at least one of A and B”.

Also, in the present disclosure, “at least one of A, B and C” may mean “only A”, “only B”, “only C”, or “any combination of A, B and C”. Also, “at least one of A, B or C” or “at least one of A, B and/or C” may mean “at least one of A, B and C”.

In addition, parentheses used in the present disclosure may mean “for example”. Specifically, when “control information (PDCCH)” is indicated, “PDCCH” may be proposed as an example of “control information”. When separately expressed, “control information” in the present disclosure may be not limited to “intra prediction”, and “PDCCH” may be proposed as an example of “control information”. Further, when “control information (i.e., PDCCH)” is indicated, “PDCCH” may be proposed as an example of “control information”.

The following technology may be used for various wireless communication systems which include code division multiple access (CDMA), frequency division multiple access (FDMA), time division multiple access (TDMA), orthogonal frequency division multiple access (OFDMA), single carrier frequency division multiple access (SC-FDMA), non-orthogonal multiple access (NOMA), and the like. The CDMA may be implemented as radio technology such as Universal Terrestrial Radio Access (UTRA) or CDMA2000. The TDMA may be implemented as radio technology such as global system for mobile communications (GSM)/general packet radio service (GPRS)/enhanced data rates for GSM evolution (EDGE). The OFDMA may be implemented as radio technology such as Institute of Electrical and Electronics Engineers (IEEE) 802.11 (Wi-Fi), IEEE 802.16 (WiMAX), IEEE 802, Evolved UTRA (E-UTRA), or the like. IEEE 802.16m as an evolution of IEEE 802.16e provides backward compatibility with a system based on IEEE 802.16e. The UTRA is part of Universal Mobile Telecommunications System (UMTS). 3rd Generation Partnership Project (3GPP) Long Term Evolution (LTE) as a part of Evolved UMTS (E-UMTS) using the E-UTRA (evolved-UMTS terrestrial radio access) adopts OFDMA in downlink and adopts SC-FDMA in uplink. LTE-Advanced (A) is evolution of LTE.

5G NR as subsequent technology is a new clean-slate type mobile communication system having features such as high performance, low latency, high availability, etc. 5G NR may utilize all available spectrum resources such as intermediate frequency band of 1 GHz to 10 GHz, a high-frequency (millimeter wave) band of 24 GHz or more, etc., from a low-frequency band less than 1 GHz.

For clear description, LTE-A or 5G NR is primarily described, but a technical spirit of the present disclosure is not limited thereto. The LTE-A or 5G NR may be referred to as an evolved-UMTS terrestrial radio access network (E-UTRAN) or long term evolution (LTE)/LTE-A system.

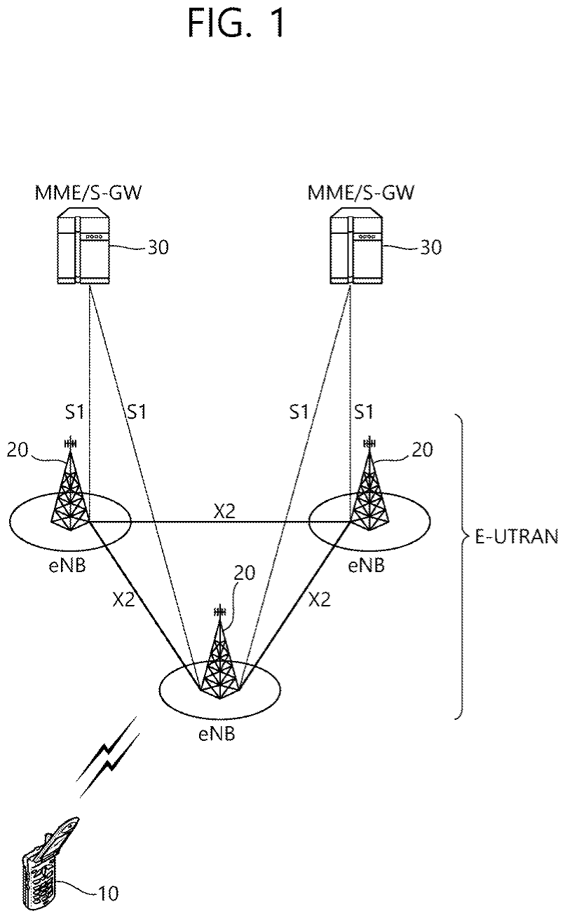

FIG. 1 shows a structure of an LTE system, in accordance with an embodiment of the present disclosure. This may also be referred to as an Evolved-UMTS Terrestrial Radio Access Network (E-UTRAN), or a Long Term Evolution (LTE)/LTE-A system.

Referring to FIG. 1, the E-UTRAN includes a base station (BS) 20, which provides a control plane and a user plane to a user equipment (UE) 10. The UE 10 may be fixed or mobile and may also be referred to by using different terms, such as Mobile Station (MS), User Terminal (UT), Subscriber Station (SS), Mobile Terminal (MT), wireless device, and so on. The base station 20 refers to a fixed station that communicated with the UE 10 and may also be referred to by using different terms, such as evolved-NodeB (eNB), Base Transceiver System (BTS), Access Point (AP), and so on.

The base stations 20 are interconnected to one another through an 23 interface. The base stations 20 are connected to an Evolved Packet Core (EPC) 30 through an S1 interface. More specifically, the base station 20 are connected to a Mobility Management Entity (MME) through an S1-MME interface and connected to Serving Gateway (S-GW) through an S1-U interface.

The EPC 30 is configured of an MME, an S-GW, and a Packet Data Network-Gateway (P-GW). The MME has UE access information or UE capability information, and such information may be primarily used in UE mobility management. The S-GW corresponds to a gateway having an E-UTRAN as its endpoint. And, the P-GW corresponds to a gateway having a Packet Data Network (PDN) as its endpoint.

Layers of a radio interface protocol between the UE and the network may be classified into a first layer (L1), a second layer (L2), and a third layer (L3) based on the lower three layers of an open system interconnection (OSI) model, which is well-known in the communication system. Herein, a physical layer belonging to the first layer provides a physical channel using an Information Transfer Service, and a Radio Resource Control (RRC) layer, which is located in the third layer, executes a function of controlling radio resources between the UE and the network. For this, the RRC layer exchanges RRC messages between the UE and the base station.

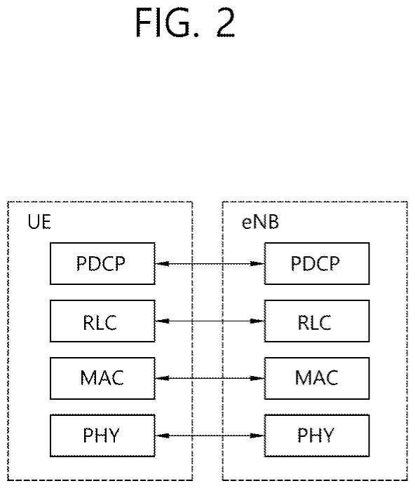

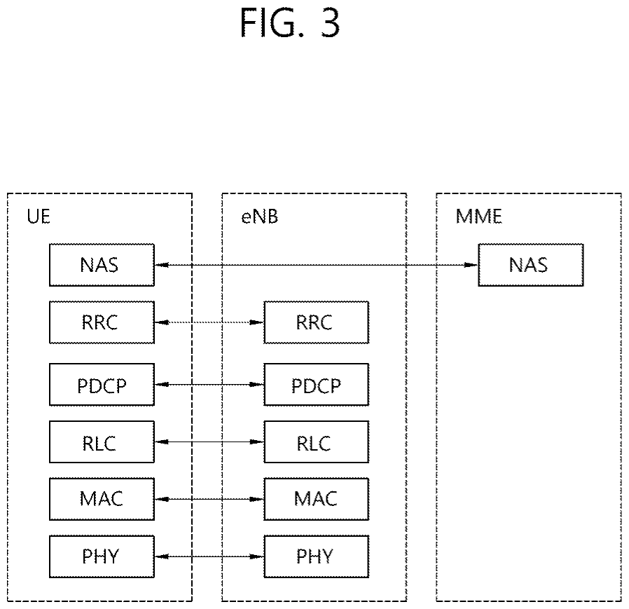

FIG. 2 shows a radio protocol architecture of a user plane, in accordance with an embodiment of the present disclosure. FIG. 3 shows a radio protocol architecture of a control plane, in accordance with an embodiment of the present disclosure. The user plane corresponds to a protocol stack for user data transmission, and the control plane corresponds to a protocol stack for control signal transmission.

Referring to FIG. 2 and FIG. 3, a physical (PHY) layer belongs to the L1. A physical (PHY) layer provides an information transfer service to a higher layer through a physical channel. The PHY layer is connected to a medium access control (MAC) layer. Data is transferred (or transported) between the MAC layer and the PHY layer through a transport channel. The transport channel is sorted (or categorized) depending upon how and according to which characteristics data is being transferred through the radio interface.

Between different PHY layers, i.e., a PHY layer of a transmitter and a PHY layer of a receiver, data is transferred through the physical channel. The physical channel may be modulated by using an orthogonal frequency division multiplexing (OFDM) scheme and uses time and frequency as radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

The radio resource control (RRC) layer is defined only in a control plane. And, the RRC layer performs a function of controlling logical channel, transport channels, and physical channels in relation with configuration, re-configuration, and release of radio bearers. The RB refers to a logical path being provided by the first layer (physical layer or PHY layer) and the second layer (MAC layer, RLC layer, Packet Data Convergence Protocol (PDCP) layer) in order to transport data between the UE and the network.

Functions of a PDCP layer in the user plane include transfer, header compression, and ciphering of user data. Functions of a PDCP layer in the control plane include transfer and ciphering/integrity protection of control plane data.

The configuration of the RB refers to a process for specifying a radio protocol layer and channel properties in order to provide a particular service and for determining respective detailed parameters and operation methods. The RB may then be classified into two types, i.e., a signaling radio bearer (SRB) and a data radio bearer (DRB). The SRB is used as a path for transmitting an RRC message in the control plane, and the DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the base station is released.

Downlink transport channels transmitting (or transporting) data from a network to a UE include a Broadcast Channel (BCH) transmitting system information and a downlink Shared Channel (SCH) transmitting other user traffic or control messages. Traffic or control messages of downlink multicast or broadcast services may be transmitted via the downlink SCH or may be transmitted via a separate downlink Multicast Channel (MCH). Meanwhile, uplink transport channels transmitting (or transporting) data from a UE to a network include a Random Access Channel (RACH) transmitting initial control messages and an uplink Shared Channel (SCH) transmitting other user traffic or control messages.

Logical channels existing at a higher level than the transmission channel and being mapped to the transmission channel may include a Broadcast Control Channel (BCCH), a Paging Control Channel (PCCH), a Common Control Channel (CCCH), a Multicast Control Channel (MCCH), a Multicast Traffic Channel (MTCH), and so on.

A physical channel is configured of a plurality of OFDM symbols in the time domain and a plurality of sub-carriers in the frequency domain. One subframe is configured of a plurality of OFDM symbols in the time domain. A resource block is configured of a plurality of OFDM symbols and a plurality of sub-carriers in resource allocation units. Additionally, each subframe may use specific sub-carriers of specific OFDM symbols (e.g., first OFDM symbol) of the corresponding subframe for a Physical Downlink Control Channel (PDCCH), i.e., L1/L2 control channels. A Transmission Time Interval (TTI) refers to a unit time of a subframe transmission.

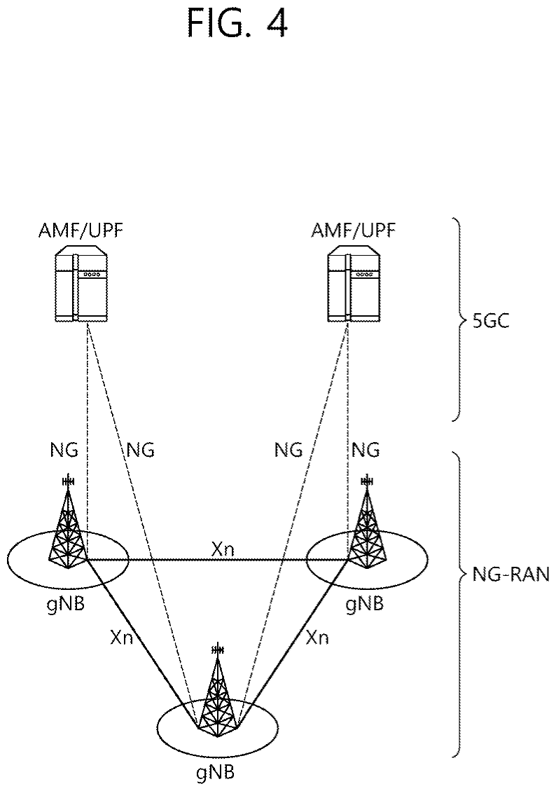

FIG. 4 shows a structure of an NR system, in accordance with an embodiment of the present disclosure.

Referring to FIG. 4, a Next Generation—Radio Access Network (NG-RAN) may include a next generation-Node B (gNB) and/or eNB providing a user plane and control plane protocol termination to a user. FIG. 4 shows a case where the NG-RAN includes only the gNB. The gNB and the eNB are connected to one another via Xn interface. The gNB and the eNB are connected to one another via 5th Generation (5G) Core Network (5GC) and NG interface. More specifically, the gNB and the eNB are connected to an access and mobility management function (AMF) via NG-C interface, and the gNB and the eNB are connected to a user plane function (UPF) via NG-U interface.

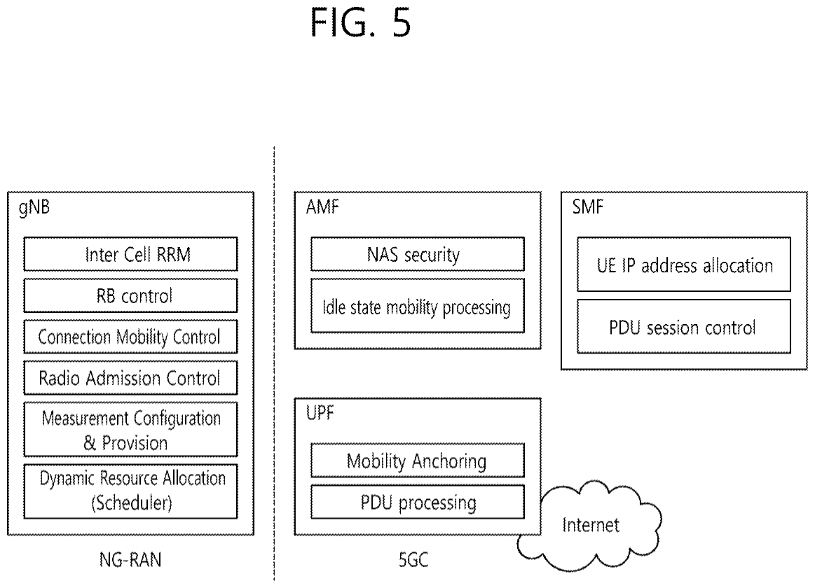

FIG. 5 shows a functional division between an NG-RAN and a 5GC, in accordance with an embodiment of the present disclosure.

Referring to FIG. 5, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

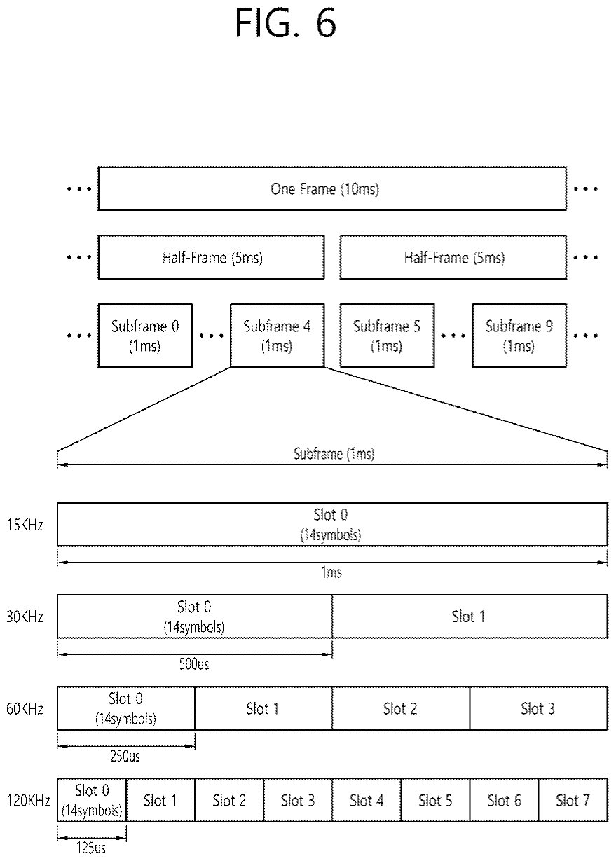

FIG. 6 shows a structure of a radio frame of an NR, in accordance with an embodiment of the present disclosure.

Referring to FIG. 6, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (N^{slot}_{symb}), a number slots per frame (N^{frame,u}ₛₗₒₜ), and a number of slots per subframe (N^{subframe,u}ₛₗₒₜ) in accordance with an SCS configuration (u), in a case where a normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = l) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table 2 shows an example of a number of symbols per slot, a number of slots per frame, and a number of slots per subframe in accordance with the SCS, in a case where an extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | |
|---|---|---|
| designation | frequency range | Subcarrier Spacing (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding | |
|---|---|---|
| designation | frequency range | Subcarrier Spacing (SCS) |
| FR1 | 410 MHz-7125 MHz | 15, 30, 60 kHz |
| FR2 | 24250 MHz-52600 MHz | 60, 120, 240 kHz |

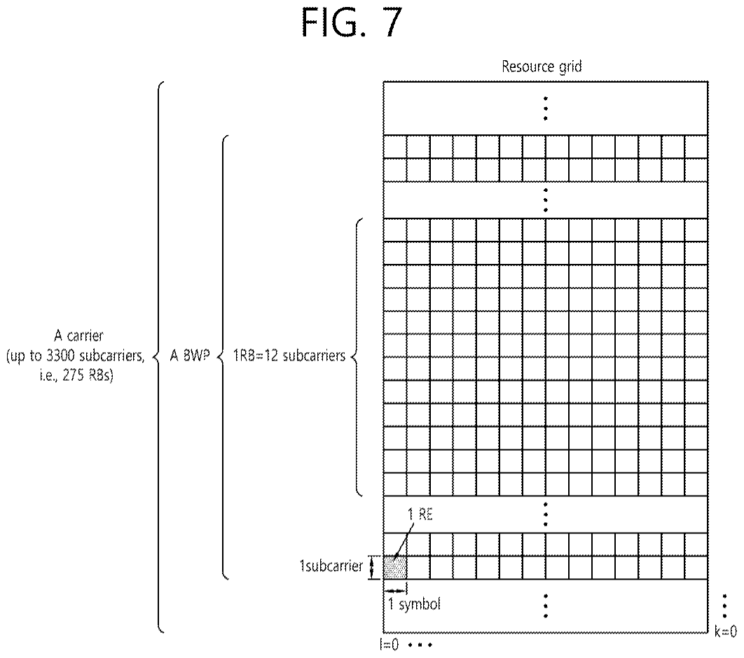

FIG. 7 shows a structure of a slot of an NR frame, in accordance with an embodiment of the present disclosure.

Referring to FIG. 7, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the location of the bandwidth may move in a frequency domain. For example, the location of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be referred to as a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit PUCCH or PUSCH outside an active UL BWP. For example, in a downlink case, the initial BWP may be given as a consecutive RB set for an RMSI CORESET (configured by PBCH). For example, in an uplink case, the initial BWP may be given by SIB for a random access procedure. For example, the default BWP may be configured by a higher layer. For example, an initial value of the default BWP may be an initial DL BWP. For energy saving, if the UE fails to detect DCI during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

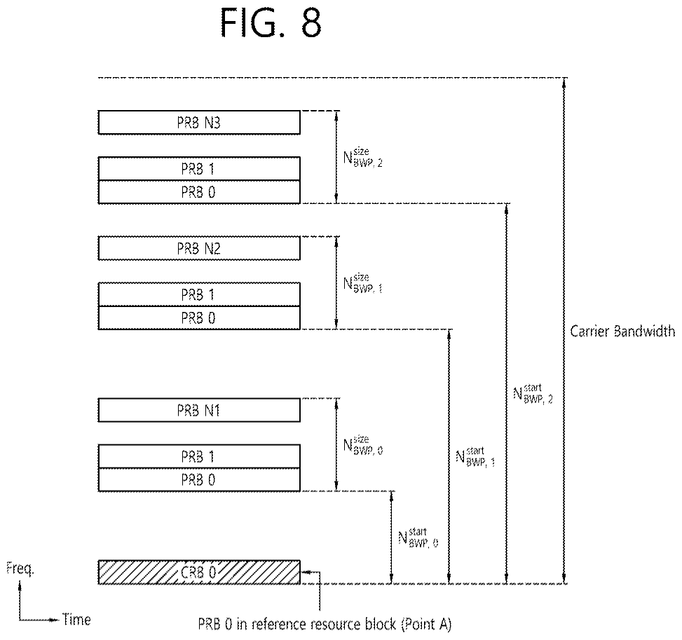

FIG. 8 shows a BWP based on an embodiment of the present disclosure. It is assumed in the embodiment of FIG. 8 that the number of BWPs is 3.

Referring to FIG. 8, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

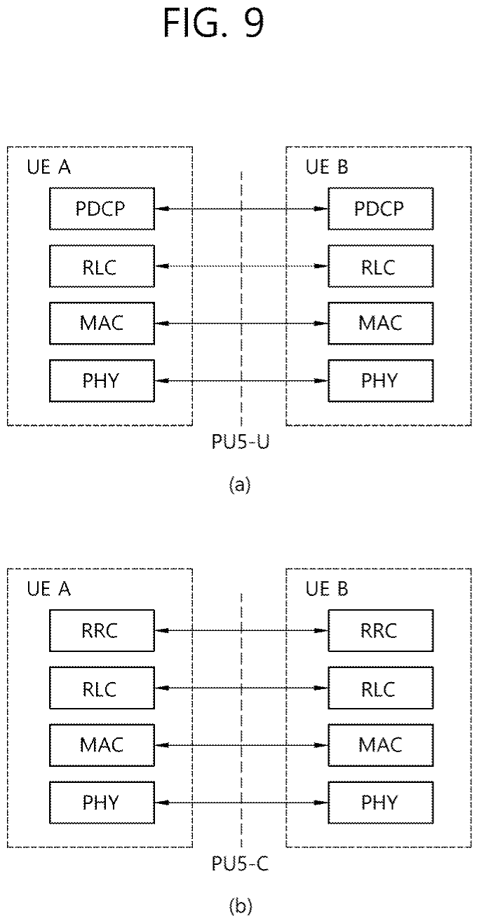

FIG. 9 shows a radio protocol architecture for a SL communication, in accordance with an embodiment of the present disclosure. The embodiment of FIG. 9 may be combined with various embodiments of the present disclosure. More specifically, (a) of FIG. 9 shows a user plane protocol stack of LTE, and (b) of FIG. 9 shows a control plane protocol stack of LTE.

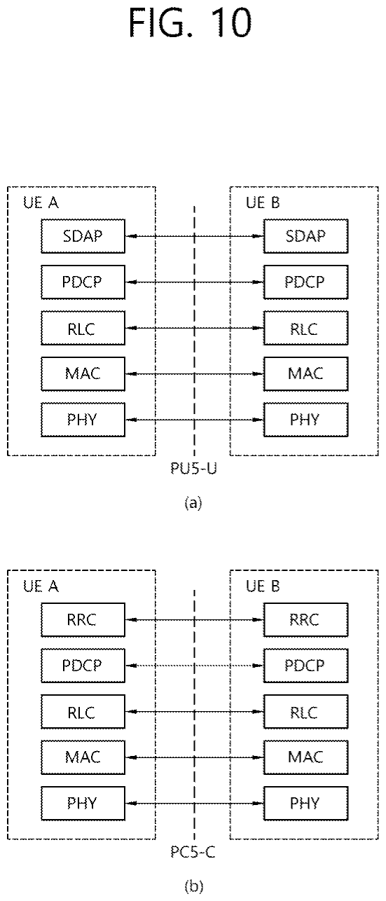

FIG. 10 shows a radio protocol architecture for a SL communication, in accordance with an embodiment of the present disclosure. The embodiment of FIG. 10 may be combined with various embodiments of the present disclosure. More specifically, (a) of FIG. 10 shows a user plane protocol stack of NR, and (b) of FIG. 10 shows a control plane protocol stack of NR.

Hereinafter, a Sidelink Synchronization Signal (SLSS) and synchronization information will be described in detail.

The SLSS is a sidelink specific sequence, which may include a Primary Sidelink Synchronization Signal (PSSS) and a Secondary Sidelink Synchronization Signal (SSSS). The PSSS may be referred to as Sidelink Primary Synchronization Signal (S-PSS) and the SSSS may be referred to as Sidelink Secondary Synchronization Signal (S-SSS).

A Physical Sidelink Broadcast Channel (PSBCH) may refer to a (broadcast) channel through which (system) information, which consist of default (or basic) information that should first be known by the UE before the sidelink signal transmission/reception. For example, the default (or basic) information may be information related to the SLSS, a Duplex Mode (DM), TDD UL/DL configuration, information related to resource pools, types of applications related to the SLSS, a subframe offset, broadcast information, and so on.

The S-PSS, the S-SSS, and the PSBCH may be included in a block format (e.g., SL synchronization signal (S S)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. In addition, a frequency position of the S-SSB may be (pre-)configured. Accordingly, the UE does not need to perform hypothesis detection at frequency to discover the S-SSB in the carrier.

Each SLSS may have a physical layer sidelink synchronization identity (ID), and the values may be respectively equal to any one value ranging from 0 to 335. Depending upon any one of the above-described values that is used, a synchronization source may also be identified. For example, values of 0, 168, 169 may indicate the GNSS, values from 1 to 167 may indicate base stations, and values from 170 to 335 may indicate that the source is outside of the coverage. Alternatively, among the physical layer sidelink synchronization ID values, values 0 to 167 may be values being used by a network, and values from 168 to 335 may be values being used outside of the network coverage.

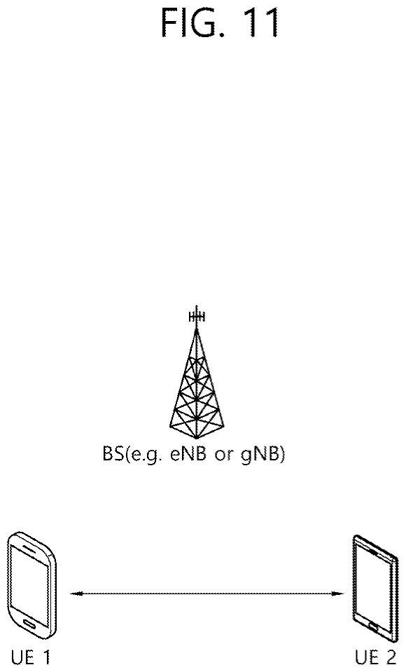

FIG. 11 shows a UE performing V2X or SL communication in accordance with an embodiment of the present disclosure.

Referring to FIG. 11, in V2X or SL communication, the term ‘UE’ may generally imply a UE of a user. However, if a network equipment such as a BS transmits/receives a signal based on a communication scheme between UEs, the BS may also be regarded as a sort of the UE.

For example, the UE 1 may select a resource unit corresponding to a specific resource in a resource pool which implies a set of series of resources. In addition, the UE 1 may transmit an SL signal by using the resource unit. For example, the UE 2 which is a receiving UE may be allocated with a resource pool in which the UE 1 is capable of transmitting a signal, and may detect a signal of the UE 1 in the resource pool.

Herein, if the UE 1 is within a coverage of the BS, the BS may inform the UE 1 of the resource pool. Otherwise, if the UE 1 is out of the coverage of the BS, another UE may inform the UE 1 of the resource pool, or the UE 1 may use a pre-configured resource pool.

In general, the resource pool may be configured based on a plurality of resource units, and each UE may select at least one resource unit for SL signal transmission.

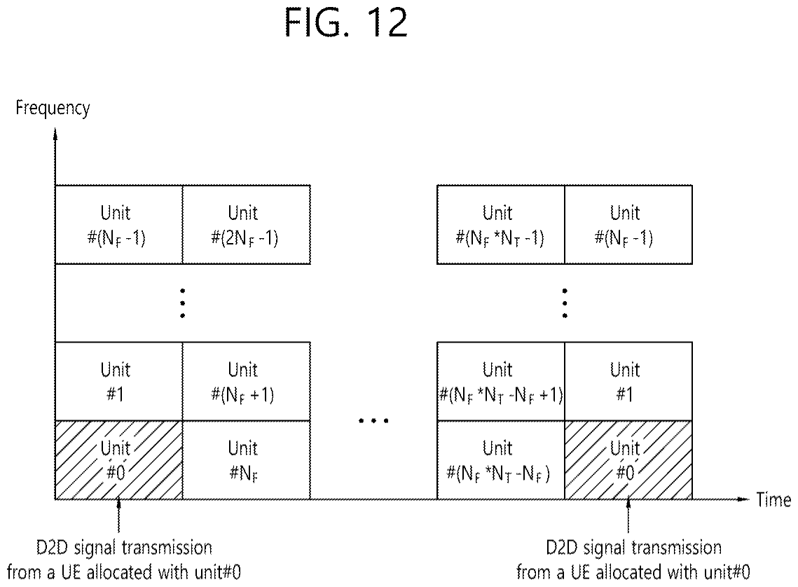

FIG. 12 shows a resource unit for V2X or SL communication based on an embodiment of the present disclosure.

Referring to FIG. 12, all frequency resources of a resource pool may be divided into N_{F} resources, and all time resources of the resource pool may be divided into N_{T} resources. Therefore, N_{F}*N_{T} resource units may be defined in the resource pool. FIG. A12 may show an example of a case where a corresponding resource pool is repeated with a period of N_{T} subframes.

As shown in FIG. 12, one resource unit (e.g., Unit #0) may be periodically repeated. Alternatively, to obtain a diversity effect in a time or frequency domain, an index of a physical resource unit to which one logical resource unit is mapped may change to a pre-determined pattern over time. In a structure of such a resource unit, the resource pool may imply a set of resource units that can be used in transmission by a UE intending to transmit an SL signal.

The resource pool may be subdivided into several types. For example, based on content of an SL signal transmitted in each resource pool, the resource pool may be classified as follows.

(1) Scheduling assignment (SA) may be a signal including information related to a location of a resource used for transmission of an SL data channel by a transmitting UE, a modulation and coding scheme (MC S) or multiple input multiple output (MIMO) transmission scheme required for demodulation of other data channels, timing advance (TA), or the like. The SA can be transmitted by being multiplexed together with SL data on the same resource unit. In this case, an SA resource pool may imply a resource pool in which SA is transmitted by being multiplexed with SL data. The SA may also be referred to as an SL control channel.

(2) An SL data channel (physical sidelink shared channel (PSSCH)) may be a resource pool used by the transmitting UE to transmit user data. If SA is transmitted by being multiplexed together with SL data on the same resource unit, only an SL data channel of a type except for SA information may be transmitted in the resource pool for the SL data channel. In other words, resource elements (REs) used to transmit SA information on an individual resource unit in the SA resource pool may be used to transmit SL data still in the resource pool of the SL data channel. For example, the transmitting UE may transmit the PSSCH by mapping it to consecutive PRBs.

(3) A discovery channel may be a resource pool for transmitting, by the transmitting UE, information related to an ID thereof, or the like. Accordingly, the transmitting UE may allow an adjacent UE to discover the transmitting UE itself.

Even if the aforementioned SL signals have the same content, different resource pools may be used based on a transmission/reception attribute of the SL signals. For example, even the same SL data channel or discovery message may be classified again into different resource pools based on a scheme of determining SL signal transmission timing (e.g., whether it is transmitted at a reception time of a synchronization reference signal or transmitted by applying a specific timing advance at the reception time), a resource allocation scheme (e.g., whether a BS designates a transmission resource of an individual signal to an individual transmitting UE or whether the individual transmitting UE autonomously selects an individual signal transmission resource in a resource pool), a signal format (e.g., the number of symbols occupied by each SL signal or the number of subframes used in transmission of one SL signal), signal strength from the BS, transmit power strength of an SL UE, or the like.

Hereinafter, a resource allocation in sidelink will be described.

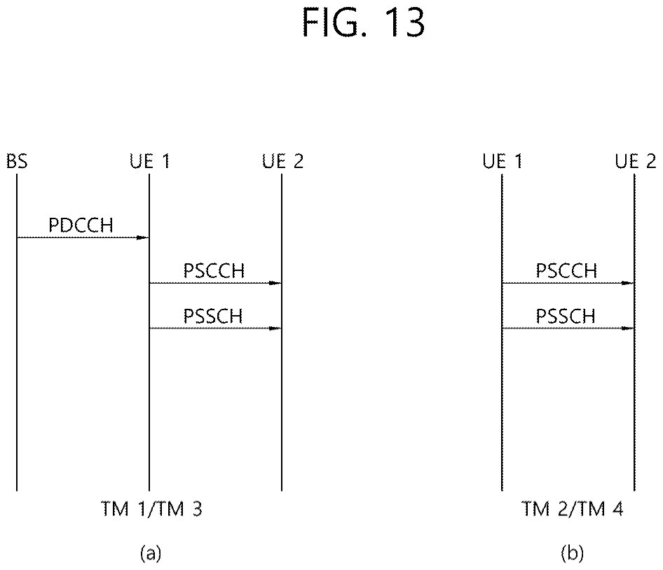

FIG. 13 shows exemplary UE operations according to a transmission mode (TM) related to V2X/D2D in accordance with an embodiment of the present disclosure. (a) of FIG. 13 shows UE operations related to Transmission mode 1 or Transmission mode 3, and (b) of FIG. 13 shows UE operations related to Transmission mode 2 or Transmission mode 4.

Referring to (a) of FIG. 13, in Transmission modes 1/3, the base station performs resource scheduling to UE 1 through a PDCCH (more specifically, DCI), and UE 1 performs sidelink/V2X communication with UE 2 in accordance with the corresponding resource scheduling. After transmitting sidelink control information (SCI) to UE 2 through a physical sidelink control channel (PSCCH), UE 1 may transmit data that is based on the SCI through a physical sidelink shared channel (PSSCH). Transmission mode 1 may be applied to sidelink, and Transmission mode 3 may be applied to V2X.

Referring to (b) of FIG. 13, in Transmission modes 2/4 may be modes according to which the UE performs self-scheduling. More specifically, Transmission mode 2 may be applied to sidelink, wherein the UE may select a resource by itself from a configured resource pool and perform sidelink operations. Transmission mode 4 may be applied to V2X, wherein, after performing sensing/SA decoding processes, and so on, the UE may select a resource by itself from a selection window and may then perform V2X operations. After transmitting SCI to UE 2, UE 1 may transmit data that is based on the SCI through the PSSCH. Hereinafter, the term Transmission mode may be abbreviated as Mode.

In case of NR sidelink, at least two types of sidelink resource allocation modes may be defined. In case of Mode 1, the base station may schedule sidelink resources that are to be used for sidelink transmission. In case of Mode 2, the user equipment (UE) may determine a sidelink transmission resource from sidelink resources that are configured by the base station/network or predetermined sidelink resources. The configured sidelink resources or the predetermined sidelink resources may be a resource pool. For example, in case of Mode 2, the UE may autonomously select a sidelink resource for transmission. For example, in case of Mode 2, the UE may assist (or help) sidelink resource selection of another UE. For example, in case of Mode 2, the UE may be configured with an NR configured grant for sidelink transmission. For example, in case of Mode 2, the UE may schedule sidelink transmission of another UE. And, Mode 2 may at least support reservation of sidelink resources for blind retransmission.

Procedures related to sensing and resource (re-)selection may be supported in Resource Allocation Mode 2. The sensing procedure may be defined as a process decoding the SCI from another UE and/or sidelink measurement. The decoding of the SCI in the sensing procedure may at least provide information on a sidelink resource that is being indicated by a UE transmitting the SCI. When the corresponding SCI is decoded, the sensing procedure may use L1 SL Reference Signal Received Power (RSRP) measurement, which is based on a Demodulation Reference Signal (SL DMRS). The resource (re-)selection procedure may use a result of the sensing procedure in order to determine the resource for the sidelink transmission.

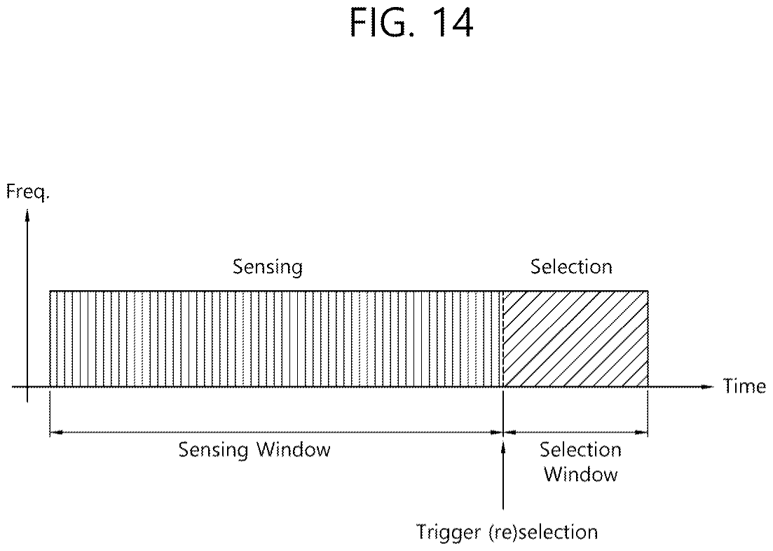

FIG. 14 shows an example of a selection of transmission resources in accordance with an embodiment of the present disclosure.

Referring to FIG. 14, by performing sensing within a sensing window, the UE may determine transmission resources reserved by another UE or transmission resources being used by another UE, and, after such transmission resources are excluded from the selection window, among the remaining resources, the UE may randomly select resources from resources having little interference.

For example, within the sensing window, the UE may decode the PSCCH including information on the cycle periods of the reserved resources and may measure PSCCH RSRP from the periodically determined resources based on the PSCCH. The UE may exclude resources having the PSSCH RSRP that exceeds a threshold value from the selection window. Thereafter, the UE may randomly select sidelink resources from the remaining resources within the selection window.

Alternatively, the UE may measure Received signal strength indication (RSSI) of the periodic resources within the sensing window, so as to determine resources having little interference (e.g., resources corresponding to the lower 20%). And, among the periodic resources, the UE may randomly select sidelink resources from the resources included in the selection window. For example, in case the UE fails to perform decoding of the PSCCH, the UE may use the above-described method.

Hereinafter, a hybrid automatic repeat request (HARQ) procedure will be described.

An error compensation scheme for securing communication reliability may include a Forward Error Correction (FEC) scheme and an Automatic Repeat Request (ARQ) scheme. In the FEC scheme, errors in a receiving end are corrected by attaching an extra error correction code to information bits. The FEC scheme has an advantage in that time delay is small and no information is additionally exchanged between a transmitting end and the receiving end but also has a disadvantage in that system efficiency deteriorates in a good channel environment. The ARQ scheme has an advantage in that transmission reliability can be increased but also has a disadvantage in that a time delay occurs and system efficiency deteriorates in a poor channel environment.

A hybrid automatic repeat request (HARQ) scheme is a combination of the FEC scheme and the ARQ scheme and it is determined whether an unrecoverable error is included in data received by a physical layer, and retransmission is requested upon detecting the error, thereby improving performance.

In case of SL unicast and groupcast, HARQ feedback and HARQ combining in the physical layer may be supported. For example, when a receiving UE operates in a resource allocation mode 1 or 2, the receiving UE may receive the PSSCH from a transmitting UE, and the receiving UE may transmit HARQ feedback for the PSSCH to the transmitting UE by using a sidelink feedback control information (SFCI) format through a physical sidelink feedback channel (PSFCH).

When the SL HARQ feedback may be enabled for unicast, in a non-code block group (non-CBG) operation, if the receiving UE successfully decodes a transport block, the receiving UE may generate HARQ-ACK. In addition, the receiving UE may transmit the HARQ-ACK to the transmitting UE. If the receiving UE cannot successfully decode the transport block after decoding the PSCCH of which the target is the receiving UE, the receiving UE may generate the HARQ-NACK. In addition, the receiving UE may transmit HARQ-NACK to the transmitting UE.

When the SL HARQ feedback may be enabled for groupcast, the UE may determine whether to transmit HARQ feedback based on a transmission-reception (TX-RX) distance and/or RSRP. In the non-CBG operation, two HARQ feedback options may be supported for groupcast.

(1) Option 1: After the receiving UE decodes an associated PSCCH, if the receiving UE fails to decode the corresponding transport block, the receiving UE may transmit an HARQ-NACK over the PSFCH. Otherwise, the receiving UE may not transmit a signal on the PSFCH.

(2) Option 2: If the receiving UE successfully decodes the corresponding transport block, the receiving UE may transmit an HARQ-NACK on the PSFCH. After the receiving UE decodes an associated PSCCH targeting the receiving UE, if the receiving UE fails to successfully decode the corresponding transport block, the receiving UE may transmit an HARQ-NACK on the PSFCH.

In case of Resource Allocation Mode 1, a time between the HARQ feedback transmission on the PSFCH and the PSSCH may be (pre-)configured. In case of unicast and groupcast, if retransmission is needed in the sidelink, this may be indicated, to the base station, by a UE existing within a coverage using a PUCCH. The transmitting UR may also transmit an indication to a service base station of the transmitting UE in the form of a Scheduling Request (SR)/Buffer Status Report (BSR) and not in the form of an HARQ ACK/NACK. Additionally, even if the base station does not receive the indication, the base station may schedule a sidelink retransmission resource to the UE.

In case of Resource Allocation Mode 2, a time between the HARQ feedback transmission on the PSFCH and the PSSCH may be (pre-)configured.

Hereinafter, the proposals of the present disclosure will be described in more detail.

The following drawings are prepared for describing one specific example of the present disclosure. A name of a specific device or a name of a specific signal/message/field disclosed in the drawings is exemplarily presented, so a technical feature of the present disclosure is not limited to a specific name used in the following drawings.

The present disclosure proposes a method for more actively protecting a person in need of protection by using communication method between devices or communication through infrastructure/network when moving between vulnerable road users (VRUs) composed of guardians and persons in need of protection.

The method proposed in the present disclosure includes a pedestrian-to-pedestrian (P2P) communication method for sharing a safety message, etc. between pedestrian terminals as well as I2P (infrastructure-to-pedestrian), N2P (network-to-pedestrian) communication method for receiving VRU protection information, etc. from surrounding infrastructure/network. Messages sent by VRUs may be collected by P2I (pedestrian-to-infrastructure) communication method from infrastructure/network, etc. to be delivered to nearby vehicles as well as approaching vehicles and/or vehicles in the blind spot, P2N (pedestrian-to-network) communication method, etc.

As an example, in order to respond to VRUs such as pet dogs and small children who have weak cognitive function or do not understand the meaning of the message displayed through the VRU device, when the VRUs deviate from the guardian, it may detect the departure of the cluster and it may be notified to the guardian by the VRU device or infrastructure/network, etc., or it may directly inform the vehicles around the VRU in need of protection, such as infrastructure/network, of a dangerous situation.

VRU refers to those who are vulnerable to traffic accidents, injuries, etc., and have low mobility or velocity compared to general vehicles on the road. Among VRUs, vulnerable VRUs such as children and pets have relatively little ability to recognize traffic conditions and protect themselves. However, the guardian may not completely protect the vulnerable VRUs at every moment, and a sudden situation that may occur in an instant may be fatal to the vulnerable VRU.

Although VRU devices can prevent safety accidents by sending warning messages to VRU users or nearby vehicles, vulnerable VRUs may not understand the messages displayed by the VRU device. Therefore, when the device of the vulnerable VRU operates the same as the device of the general VRU, the vulnerable VRU may not be able to cope with a dangerous situation. It is necessary to always monitor the status of the vulnerable VRU by the M-VRU (master-VRU), to prevent an unexpected situation, and to immediately notify the situation when an unexpected situation occurs. Nearby vehicles also need a way to more clearly recognize the situation that may or may not be caused by a vulnerable VRU.

Accordingly, the present disclosure describes a method for maintaining a cluster in a moving state of a corresponding VRU cluster by pre-registration between known VRUs configured in a relationship between a guardian and a person in need of protection. In addition, the present specification proposes a method for creating a cluster in various mobility situations among members, and a method for VRUs to maintain a cluster in a situation where the VRUs move and to update cluster information based on previously received information. In addition, when some VRUs fail to maintain a cluster, a method for preventing an accident by detecting VRU departure information within the cluster or sharing it with the outside is proposed. Meanwhile, in the present disclosure, mobility may include velocity, speed, movement direction, distance between devices, and the like.

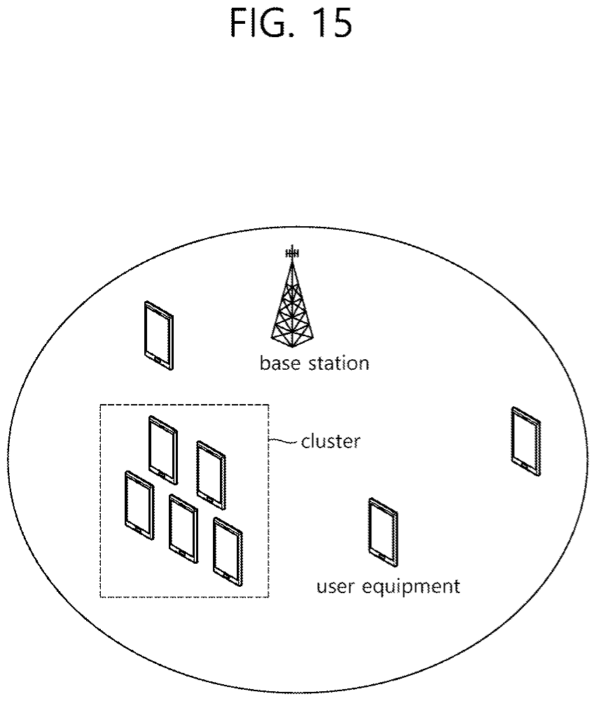

FIG. 15 is for explaining a cluster. Here, the cluster may refer to a group in which VRUs are connected to each other and operate as one system or one terminal. Also, clustering may refer to an act of creating/forming the cluster.

FIG. 15 is an assumption that a plurality of terminals exist within the coverage of the base station. Referring to FIG. 15, some terminals among a plurality of terminals within coverage may be clustered to configure one cluster. As a condition of cluster configuration, a similar level of movement velocity, movement direction, etc. can be considered.

Meanwhile, although FIG. 15 shows only clusters within the coverage of the base station, this is only an example, and clusters may be created between terminals belonging to different coverages. Also, here, each of the terminals constituting the cluster may be a terminal that satisfies a configuration condition. For example, the movement velocity of each of the terminals constituting the cluster may be similar and may not exceed a velocity-related threshold. In addition, each of the terminals constituting the cluster may be a terminal located within a predetermined distance from the center of the cluster.

Hereinafter, a method for configuring a cluster will be described.

As an example, in the case of VRUs configured as guardians and objects of protection, after the guardian VRU (hereinafter, M (master)-VRU) controls devices of VRUs (hereinafter, V (very)-VRUs) to be protected or searches for devices of V-VRUs, it can be configured as one VRU group or cluster. Specifically, when a cluster is configured, the M-VRU may become a representative of the cluster and communicate with the base station or perform cluster management such as configuration and release of the cluster. The following operations may be performed according to the characteristics of the VRU device.

With respect to cluster consisting, a cluster may be formed between VRUs that are not related to each other. A cluster configured between unrelated VRUs may be referred to as a free cluster. Alternatively, the M-VRU or the representative VRU may register the V-VRUs in the cluster. For example, a group such as a family composed of M-VRUs and V-VRUs rather than a VRU cluster composed of arbitrary VRUs may be pre-configured as a cluster.

In relation to cluster consisting, the following cases may exist.

(Case 1) when VRU Members Use the Same Device and the Same Application

With respect to case 1, a case in which the V-VRU is dependent on the M-VRU may be considered.

Specifically, in a user experience (Ux) situation on an application or on a system related to clustering, an M-VRU or V-VRU may request clustering and scan another user's device. When cluster registration is allowed, cluster consisting of M-VRU and V-VRU is established, and related information can be transmitted over the network. For example, based on a list containing, for example, an identifier (ID) that can identify another member's device, such as an address book, the M-VRU can search for a member such as V-VRU and send a message to that member, the member who receives the message can perform an appropriate action by sending a response message or pressing a button.

(Case 2) when M-VRU is a General Device and V-VRU is a Device that is Dependent on M-VRU

In relation to case 2, a case in which the M-VRU discovers a device of the V-VRU and performs registration and pairing may be considered.

Specifically, when the device of the V-VRU is turned on, when the device of the V-VRU is tagged with the device of the M-VRU by near field communication (NFC), etc., or when the mobility of M-VRU and V-VRU is similar, a mutual connection can be established. Here, the case in which mobility between devices is similar may mean a case in which velocity, direction, etc. are similar within a specific error range or a case in which the distance between devices is less than or equal to a specific threshold. On the other hand, when cluster consisting is completed, related information may be transmitted to the network.

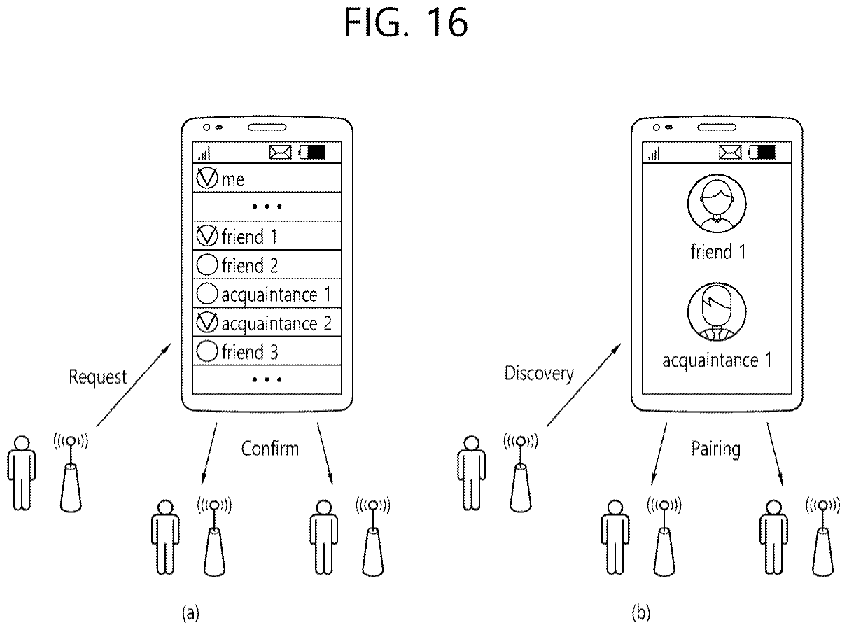

FIG. 16 schematically shows examples of constituting a cluster. Specifically, (a) of FIG. 16 schematically shows an example of case 1, (b) of FIG. 16 schematically shows an example of case 2.

Referring to (a) of FIG. 16, a specific user can request a cluster consisting of other users in the address book or list displayed in the application, etc. by using the user's own device. The other users using the same application can receive the request message, a cluster consisting request can be accepted through an indication of acceptance, such as a response message. A cluster is created through the above process, and related information may be transmitted to the network.

Referring to (b) of FIG. 16, a specific user can search for other users using the user's own device. Then, when other users are found, the user may register other users or perform pairing. A cluster is created through the above process, and related information may be transmitted to the network.

Meanwhile, after the VRU detects mobility and operates in the VRU mode, it can detect a neighboring cluster (a normal cluster or a free cluster) and join the cluster. Alternatively, the VRU may detect an existing subscribed cluster (e.g., a subscribed cluster) and join the cluster. In a situation in which the M-VRU and V-VRU constituting the subscription cluster are moved, the process of recognizing and clustering the members of the cluster at the beginning may occur, in addition, some members, particularly V-VRUs, may leave while maintaining the cluster or moving while maintaining mobility. In this case, in order to prevent an accident, it is necessary to notify the M-VRU as well as the surrounding network and/or vehicles.

Hereinafter, the VRU mode will be described. Here, the VRU mode may be a mode in which cluster consisting and/or subscription is allowed to protect the VRU.

It may enter VRU mode because the VRU moves only indoors, or move out of a VRU protected area, or the VRU unit is not moving and then relocates to an outdoor area or VRU protected area, or VRU mobility detection, etc.

Here, the specific area-related information is predefined and stored in a high definition map (HD MAP) or the like, or may be transmitted from a higher network to the terminals through a road side unit (RSU), an eNB, a gNB, etc. Whether a VRU is indoors or in a VRU protected area can be checked through comparing VRU location information obtained from GPS, Wi-Fi hotspot, etc. with VRU mapping information on HD MAP, or area-related information received from networks, etc. Based on this information, it is possible to enter VRU mode only in outdoor areas designated as VRU protected areas, among indoor areas, it is possible to switch to VRU mode or lost child prevention mode in indoor places other than frequently visited or pre-designated places such as home and school. In addition, mobility may be detected through an acceleration sensor, a gyro sensor, a geomagnetic sensor, or a GPS sensor capable of measuring a location of the VRU device. Meanwhile, the VRU protection zone may include a hazardous area such as a school zone, a crosswalk, and a driveway.

Hereinafter, cluster detection will be described.

In a situation where M-VRU and V-VRU move together, the M-VRU directly coordinates the devices of the V-VRU, or the M-VRU runs clustering mode on the devices of the M-VRU, etc., it can directly input the context to communicate the movement status of the cluster to the network and/or peripheral devices. However, if the M-VRU and V-VRU are not moving together, it may be necessary for the M-VRU to detect the operation of the V-VRU or for the V-VRU to detect the operation of the M-VRU and take an action corresponding thereto. The cluster detection operation can be performed in the following situations.

(Situation 1) When M-VRUs do not move and at least one V-VRU with the same or more V-VRUs moves: When V-VRU mobility is detected or the base station receives a message transmitted periodically by the V-VRU or a message transmitted through a scheduled resource, or the device of the V-VRU detects its own mobility through GPS, accelerometer, gyro sensor, etc., for the corresponding event, the corresponding situation is directly transmitted to the base station, and the network provides a notification message to the device of the M-VRU. As a specific example, the movement of the V-VRU may be detected while periodically receiving a message containing location information and velocity information or periodically receiving a beacon, a reference signal, and the like.

(Situation 2) When M-VRU moves and V-VRU does not: The base station may periodically receive a message containing the location of the V-VRU(s), mobility-related information, or the like, or may receive a report from the V-VRU and instruct the M-VRU when an event related to mobility occurs. In this case, if the V-VRU does not move, the base station notifies the M-VRU that the V-VRU is in a static state or does not perform a special operation. On the other hand, the base station informs the V-VRUs about the movement status of the M-VRUs. Afterwards, when a change in the location, mobility, etc. of the V-VRU is detected, the base station receives a mobility-related message from the V-VRU as described above, the base station may inform the device of the M-VRU of the movement of the V-VRU through a notification message or the like.

(Situation 3) When an M-VRU and at least one same or more V-VRUs move together: As described above, through the method in which the M-VRU directly controls the device of the V-VRU or the M-VRU directly inputs the situation to the device of the M-VRU, etc., the movement status of the corresponding cluster may be communicated to the network and/or peripheral devices. Alternatively, the M-VRU and V-VRU may each transmit mobility-related information to a base station by combining the above methods. Thereafter, a network-based VRU clustering operation may be performed.

Meanwhile, in the case of a subscription cluster, since all members are VRUs registered in advance, the clustering method may also be different from the clustering method between arbitrary VRUs. As an example, the M-VRU may directly cluster members, or may be clustered in such a way that members each request registration in the cluster.

Hereinafter, a clustering method for a subscription cluster will be described. Clustering may refer to an operation/method of consisting a cluster.

First, a method of direct clustering by a representative VRU may be considered. Specifically, the representative VRU scans the surrounding VRUs and periodically transmits a safety message such as a public safety message (PSM) message, when a VRU that satisfies the clustering condition is found, the VRU is included in the cluster, a response message may be transmitted to the corresponding VRU or updated cluster information including the corresponding VRU may be transmitted to the corresponding VRU through a message such as a PSM message. Here, the representative VRU may be an M-VRU, and the neighboring VRU may be a V-VRU.

Alternatively, a method in which members directly cluster may be considered. M-VRU and V-VRU may be the members. As an example, the M-VRU scans the surrounding V-VRUs and periodically transmits a safety message such as a PSM message, it is checked whether a VRU that satisfies the clustering condition is found. In addition, when the V-VRU also scans PSM messages or clustering-related messages and a cluster is found that has performed the pre-registration procedure, clustering is completed by sending a message joining the cluster to the M-VRU. Here, the clustering message may be a message transmitted by a cluster in which the VRU has performed a pre-registration procedure or a message transmitted by a pre-paired cluster.

Here, the clustering condition may mean, for example, that the distance from the representative VRU (e.g., M-VRU) or the distance from the central location of the cluster is less than or equal to a certain threshold, or that a reception level (e.g., reference signal received power (RSRP)) for a transmitted signal (e.g., a PSM message) is equal to or greater than a certain threshold, or that the difference in velocity, directionality, etc. with the representative VRU and/or cluster is equal to or less than a certain threshold.

Meanwhile, the following method may be considered according to the type of VRU device.

(Example 1) When both the device of the M-VRU and the device of the V-VRU are cellular devices, when a VRU entering VRU mode scans a safety message for a subscribed cluster and receives a PSM message, clustering can be performed with the corresponding VRU.

Here, if the PSM message is not detected, the VRU may transmit the PSM message to neighboring VRU devices through the PC5 interface using its own VRU device.

Alternatively, the VRU may transmit a message notifying the change of its mobility to the base station through the Uu interface using its VRU device. In this case, the base station may transmit a message to other VRUs in the subscription cluster to inform it or perform VRU paging. Thereafter, when mobility of other VRUs occurs or other VRUs enter the VRU mode, the VRU may determine whether to join the cluster by reconfirming the mobility of the VRU.

(Example 2) When the device of the M-VRU is a cellular device and the device of the V-VRU is a low-power device, the case where the M-VRU enters the VRU mode or the V-VRU enters the VRU mode may be considered, respectively. When the M-VRU enters the VRU mode, the M-VRU may instruct the V-VRU to join the cluster by performing a scan on the V-VRU. When the V-VRU enters the VRU mode, the V-VRU may recognize its VRU mode change and scan a representative VRU (e.g., M-VRU) of a cluster to which it will join.

Here, the low-power device may be a device using Bluetooth, a beacon signal, or the like. Also, here, each operation of Example 2 may be performed through Bluetooth, a beacon, or the like.

Hereinafter, transmission of a cluster-related message will be described.

As an example of cluster-related message transmission, a specific VRU in the cluster may transmit a cluster-related message or a message representing the cluster. In this case, it may not be necessary for all VRUs constituting the cluster to each transmit a PSM message.

Here, the cluster-related message or the message representing the cluster may be transmitted by the VRU representing the cluster. The VRU representing the cluster may be an M-VRU, the VRU with the highest battery power in the VRU unit, the VRU that has the most time remaining until the VRU unit is fully discharged, or the VRU with the most cellular resources left of the VRU device. At this time, when transmitting the cluster-related message or a message representing the cluster, the power level of the VRU device, the remaining cellular resources, etc. may be included in the message and transmitted.

Also, here, the VRUs constituting the cluster may alternately transmit in order. When the order of transmitting messages representing the cluster between VRUs in the cluster is set, the VRU at which the transmission time has arrived may transmit updated cluster information on a resource reserved in accordance with the PSM period.

As another example of cluster-related message transmission, when an event related to a cluster or a VRU within a cluster occurs, information on the event may be transmitted by the VRU within the cluster. That is, the above example is an example of a message transmitted when an event occurs. Here, a resource through which a message transmitted when an event occurs may be different from a resource through which a periodically transmitted message is transmitted.

As a specific example, when a cycle to update cluster information arrives, a representative VRU that periodically transmits a PSM message or a VRU whose transmission order has arrived may transmit information on the location, velocity, direction, path, etc. of the VRU.

On the other hand, the representative VRU may be changed to another VRU in the cluster according to the specific situation of the VRU device (remaining battery level, remaining cellular resource amount, etc.). Alternatively, when the battery level and power level of a specific VRU device are equal to or larger than the threshold value of the device of the representative VRU and are maintained for a certain period of time equal to or longer than that of the device, the specific VRU device may be determined as the representative VRU device.

Hereinafter, cluster management will be described. Here, cluster management may be performed based on mobility.

As an example of cluster management, the M-VRU may transmit a safety message, and the V-VRUs may receive the message and determine whether to leave the cluster based on the message. Specifically, each V-VRU may determine whether to continue to be included in the cluster based on the mobility of the M-VRU (e.g., location, velocity, movement direction, etc.) or the mobility of the cluster. In this case, information on the mobility of the M-VRU may be obtained through a safety message transmitted by the M-VRU. In addition, when an M-VRU or another V-VRU transmits information about the cluster, information on cluster mobility can be obtained through a message transmitted by the corresponding VRU.

As another example of cluster management, a case in which a PSM message is transmitted not only to M-VRUs but also to V-VRUs may be considered. In this case, each of all VRUs in the cluster may receive a message transmitted by another VRU to obtain mobility-related information. In this case, mobility-related information included in the message transmitted by the representative VRU may be a standard for cluster management, based on the criteria, each of the VRUs that have received the message transmitted by the representative VRU may determine whether to continue to be included in the cluster. On the other hand, when the representative VRU does not always transmit a safety message, mobility-related information included in a message commonly transmitted by each of the VRUs in the cluster may be the criterion. Here, the message commonly transmitted by each of the VRUs in the cluster may include cluster information and cluster mobility information.

Hereinafter, cluster departure detection will be described.

As the most common cluster departure situation, V-VRU cluster departure can be considered. When a change in mobility of a specific V-VRU is detected, the specific V-VRU may directly transmit a message indicating a change in mobility, a representative VRU (e.g., M-VRU) may detect this and determine it as a cluster departure symptom. In this case, the change in mobility may be detected based on the mobility of the M-VRU or the mobility of the cluster. However, when detecting a change in mobility based on the mobility of the cluster, when it is detected that the M-VRU has left the cluster, an operation for notifying the M-VRU that it has left the cluster may also be required.

Meanwhile, when a VRU leaves a cluster near an M-VRU, the base station may transmit a warning message only to VRUs in the corresponding cluster. The range near the M-VRU may mean a range within a certain distance based on the M-VRU's viewing range or the center of the M-VRU and/or the cluster.

As a specific example of cluster departure, it may include a case in which the difference between the location of a specific VRU and the “cluster center location acquired by the base station or the reference location of the cluster such as M-VRU” is equal to or greater than the threshold value, a case in which the V-VRU directly transmits a cluster departure notification message to the base station, or a case in which the M-VRU discovers the departure of the V-VRU from the cluster and directly informs the base station of the departure of the V-VRU from the cluster. Here, a case in which the above-mentioned cases continue for the same or more than a certain period of time, or a case in which an M-VRU communicates directly to the corresponding V-VRU (e.g., unicast or PC5 interface-based communication) and there is no response for the same or abnormal time for a certain period of time can be defined as leaving the cluster.

A case in which a specific V-VRU deviates from the center of the M-VRU or cluster by more than or equal to the threshold, etc., if it is determined that a specific VRU leaves the cluster further than the range near the M-VRU, the M-VRU or other V-VRUs in the cluster may transmit a warning message about an unexpected situation to surrounding vehicles and/or networks.

Specifically, the M-VRU directly informs the base station of cluster departure of a specific V-VRU, or the base station may detect the safety message transmitted by the specific V-VRU and transmit a warning message to surrounding vehicles. In this case, the safety message transmitted by the specific V-VRU may include information about the cluster departure of the specific V-VRU.

Furthermore, the network may request inspection/discovery of surrounding VRUs with an ADAS camera from surrounding vehicles. For a specific example, the network provides information about lost children, which is information about VRUs that have left the cluster, to nearby vehicles, the vehicle itself uses artificial intelligence-based image recognition to check whether the VRU has been found, if found, the reading result and corresponding photo and video information can be transmitted to the network. As another example, surrounding vehicles acquire information about a VRU that has left the cluster, when an ADAS video included in the corresponding category is acquired, it is transmitted to the network, it may allow the network to read whether a VRU has left the cluster.

Additionally, the network may request the traffic control center to adjust the signal around the moving path of the out-of-cluster VRU. Specifically, it may be requested to control a signal within a controllable range according to the moving direction, coverage, etc. of the VRU leaving the cluster. For example, in the case of a crossroads intersection, rather than changing all four signals, some signals related to the direction of movement can be controlled by prematurely terminating the driving signal or notifying a warning situation. As a method of notifying a warning situation, repeated blinking of a green light may be considered.

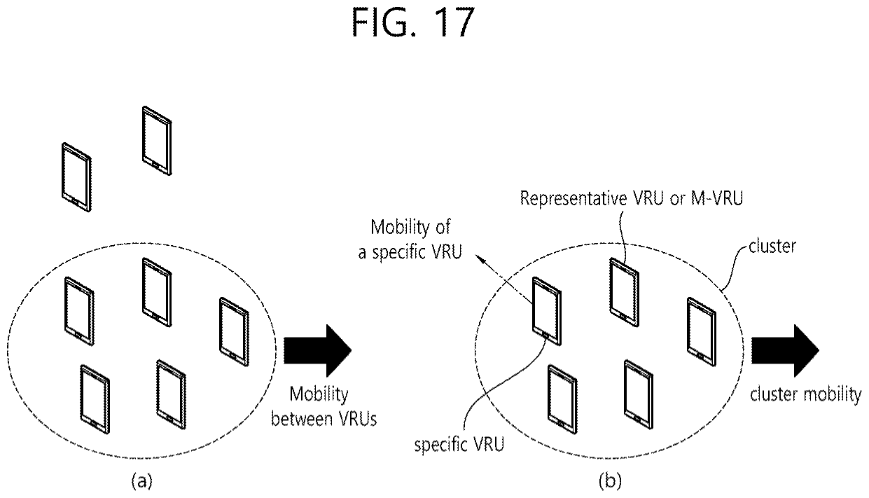

FIG. 17 schematically illustrates an example of clustering and cluster departure detection. Specifically, (a) of FIG. 17 shows an example of clustering, and (b) of FIG. 17 shows an example of cluster departure detection.

Referring to (a) of FIG. 17, there may be VRUs or VRU terminals having mobility that satisfy the criteria or conditions of cluster consisting. In this case, if a representative VRU or M-VRU exists, a cluster may be generated by the above-described clustering method.

Referring to (b) of FIG. 17, a specific VRU having mobility different from the cluster mobility may exist in a cluster having cluster mobility. In this case, as described above, the representative VRU may detect whether the specific VRU has departed from the cluster.

Hereinafter, the V2X message related to the cluster will be described.

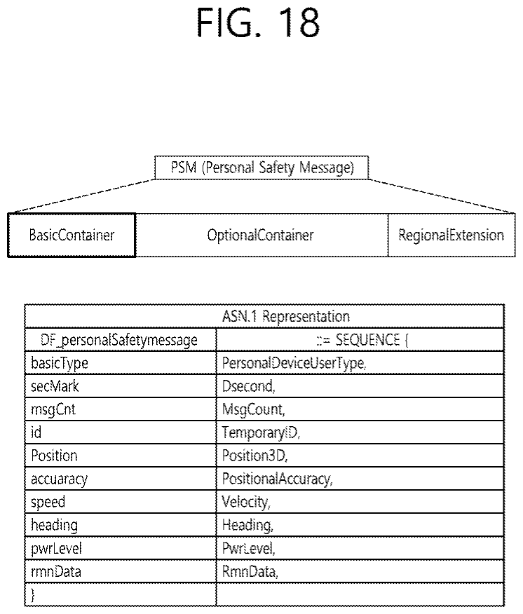

FIG. 18 schematically illustrates an example of a configuration of a PSM message according to some implementations of the present disclosure. Specifically, the PSM message of FIG. 18 may include information related to a pedestrian terminal or VRU clustering.

FIG. 18 shows a configuration of a PSM message and fields of a basic container. Here, the PSM message may include information on a power level or available data amount for a VRU transmitting the PSM message.

For example, the power level may be expressed as a percentage of the amount of remaining power, and in this case, the power level related field may consist of 7 bits.

Also, here, the amount of available data may be expressed in megabytes, since data consumption for PSM message transmission is relatively large, information on gigabyte units may be relatively insignificant. Accordingly, when the amount of available data is equal to or greater than a certain amount, the related field may be expressed as a maximum value. For example, if the maximum value is 32 gigabytes, the field for the amount of usable data may consist of 15 bits (for example, from 1 megabyte to 32767 megabytes expressed in units of 1 megabyte). If the field size needs to be reduced, the amount of data can be measured and expressed in larger units (for example, in units of 2 megabytes or 5 megabytes), or the maximum value can be set smaller.

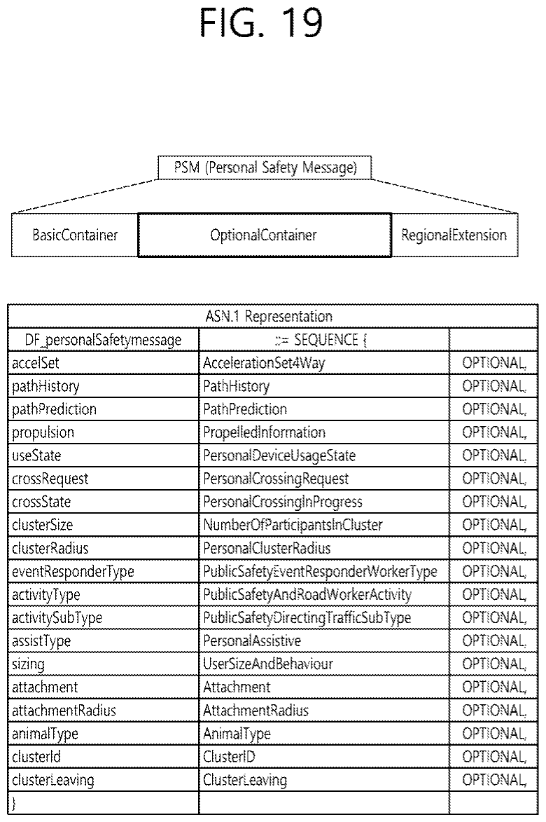

FIG. 19 schematically illustrates another example of a configuration of a PSM message according to some implementations of the present disclosure.

FIG. 19 shows a configuration of a PSM message and fields of an optional container. In particular, among the fields, the clusterLeaving field may be expressed as ON when the VRU transmitting the PSM message determines by itself that the cluster consisting condition is not satisfied, and OFF when not. That is, the field may consist of 1 bit.

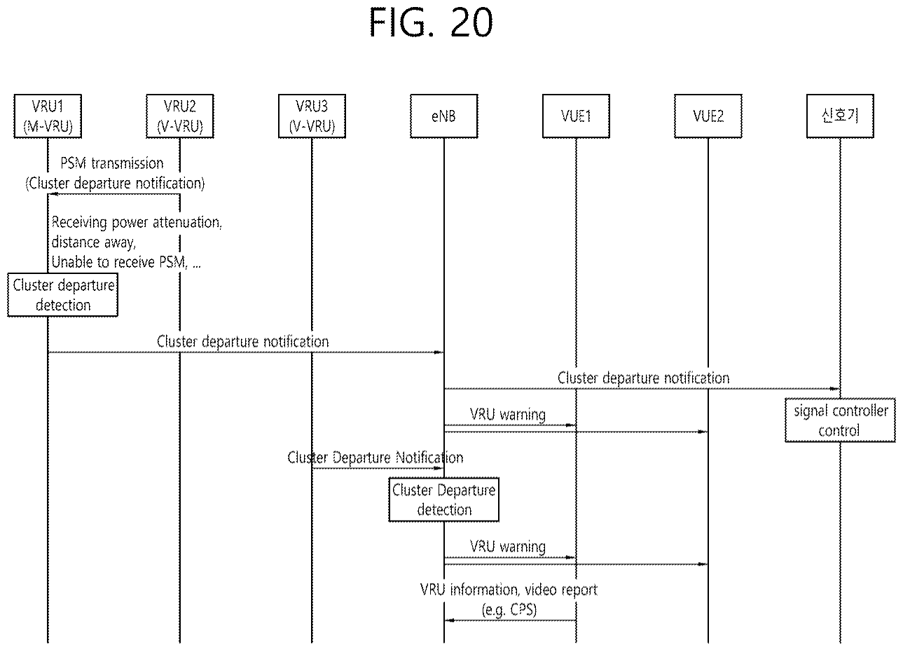

FIG. 20 is a flowchart of an example of a method for detecting an out-of-cluster VRU according to some implementations of the present disclosure. Here, each step or operation shown in FIG. 20 may be performed alone or simultaneously.

FIG. 20 shows a situation in which VRU1, VRU2, and VRU3 form a cluster, and it is assumed that the representative VRU of the cluster is VRU1. Referring to FIG. 20, VRU2 may transmit a PSM message to VRU1 to inform cluster departure, or VRU1 may estimate a distance to VRU2 based on the PSM message. Through this, VRU1 may detect that VRU2 has left the cluster, and may notify the base station of VRU2's departure from the cluster.

The base station may request signal control to the signal controller after confirming that the VRU2 is out of the cluster. The signal controller may control the signaler based on the request.

In addition, after confirming the departure of the VRU2 from the cluster, the base station may notify the surrounding vehicles (VUE1 and VUE2) of the existence of the VRU leaving the cluster through a warning message or the like.

Alternatively, a VRU (VRU3) other than the representative VRU may detect the departure of the VRU2 from the cluster and inform the base station of the departure of the VRU2 from the cluster directly through a PSM message or the like. Even in this case, the base station can notify the surrounding vehicles (VUE1 and VUE2) of the existence of a VRU that has left the cluster through a warning message or the like after confirming the departure of the VRU2 from the cluster.

On the other hand, when a nearby vehicle that has received the warning message discovers VRU2 through a sensor, a camera, or the like, it may notify the base station of this. Specifically, the VRU2 may transmit a captured image or transmit information related to the VRU2.

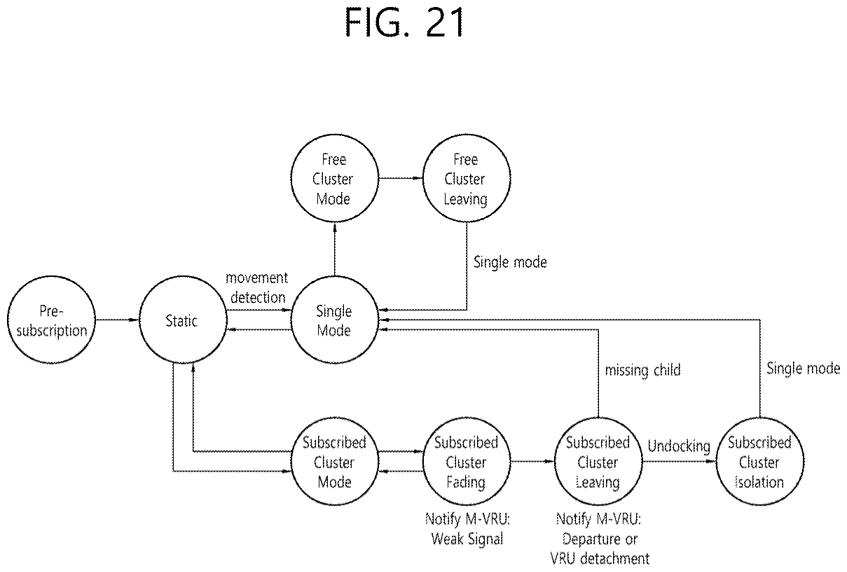

FIG. 21 is a flowchart of an example of a clustering state change in accordance with some implementations of the present disclosure. Specifically, FIG. 21 shows a state change of clustering between arbitrary VRUs (free clustering) and/or clustering between known VRUs (subscribed clustering).

For example, if a specific VRU does not subscribe to any cluster without pre-subscription, since it only switches to the free clustering mode and leaves the cluster, other VRUs (e.g., guardian of a specific VRU, etc.) do not perform an operation to include the specific VRU back into the cluster even if mobility occurs in the static state of the specific VRU, the specific VRU operates in a single mode when mobility occurs.

Meanwhile, when a specific VRU subscribes to a specific cluster, the specific VRU may enter a subscribed clustering mode when mobility occurs in a static state.

In addition, when a cluster departure situation starts in the subscription clustering mode (i.e., when there is a risk of cluster departure), the specific VRU may be switched to a subscribed cluster fading mode. In this case, the representative VRU of the specific cluster or another VRU may transmit a warning message or the like to the specific VRU to inform that the specific VRU is likely to leave the specific cluster. Thereafter, when the specific VRU is re-entered or reconfigured in the specific cluster, the specific VRU may be re-changed to the subscription cluster mode. Or, if the subscription cluster fading mode has elapsed for the same or more than a certain period of time, the specific VRU may be determined to have left the specific cluster. In this case, when the representative VRU within a specific cluster recognizes the departure of the specific VRU and terminates the situation, the specific VRU may switch to the single mode. In addition, the specific VRU leaving the specific cluster may be configured in a cluster other than the specific cluster to operate in a subscription clustering mode again, or may be configured in a free cluster and operate in a free cluster mode.

For a specific example related to FIG. 21, there may be a subscription cluster (which can be matched to the specific cluster) consisting of a person to be protected, such as a small child, and a parent of a small child, it matches the young child to the specific VRU, it can match another subscription cluster to a cluster associated with the child's class, a free cluster may be matched to a cluster consisting of the young child and the young child's friends with similar movement paths.

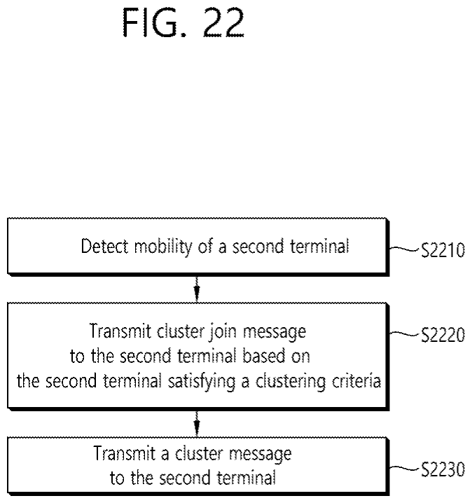

FIG. 22 is a flowchart of a method for managing a cluster of a first terminal according to some implementations of the present disclosure.

Referring to FIG. 22, the first terminal detects the mobility of the second terminal (S2210).

Thereafter, the first terminal transmits a cluster join message to the second terminal on the basis that the second terminal satisfies the clustering condition (S2220). Here, the cluster join message may include information requesting the second terminal to join the cluster including the first terminal and the second terminal. Also, here, the clustering condition may mean that the distance from the first terminal or the distance from the center position of the cluster of the second terminal of the second terminal is equal to or less than a specific threshold, that a reception level (e.g., reference signal received power (RSRP)) for a signal (e.g., a PSM message) transmitted from the second terminal is equal to or greater than a specific threshold, or that a difference in velocity, direction, etc. with the first terminal and/or cluster is equal to or less than a specific threshold value, as described above.

Thereafter, the first terminal transmits a cluster message to the second terminal (S2230). Here, the cluster message may include information related to the cluster and mobility of the cluster.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method.

The methods proposed in this specification can also be performed by, in addition to the terminal, at least one computer readable medium including instructions based on being executed by at least one processor (computer readable medium), the apparatus configured to control the terminal including one or more processors and one or more processors operably coupled by the one or more processors, and one or more memories for storing instructions, where the one or more processors execute the instructions to perform the methods proposed herein. Also, it is obvious that, according to the methods proposed in this specification, an operation by the base station corresponding to the operation performed by the terminal may be considered.

Hereinafter, an example of a communication system to which the present disclosure is applied will be described.

Although not limited to this, various descriptions, functions, procedures, proposals, methods, and/or operation flowcharts of the present disclosure disclosed in this document may be applied to various fields requiring wireless communication/connection (e.g., 5G) between devices.

Hereinafter, it will be exemplified in more detail with reference to the drawings. In the following drawings/descriptions, the same reference numerals may represent the same or corresponding hardware blocks, software blocks, or functional blocks, unless otherwise indicated.

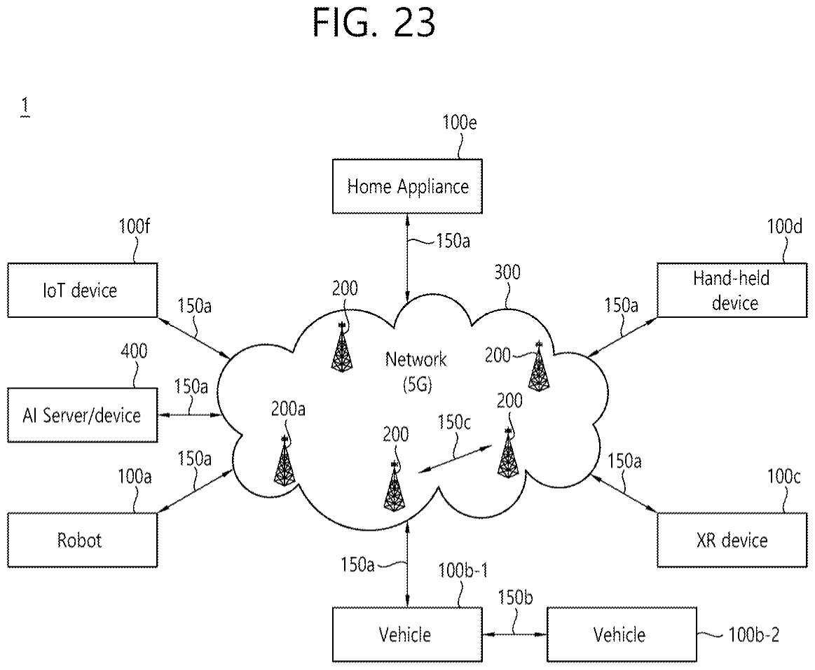

FIG. 23 shows a communication system (1), in accordance with an embodiment of the present disclosure.

Referring to FIG. 23, a communication system (1) to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot (100a), vehicles (100b-1, 100b-2), an eXtended Reality (XR) device (100c), a hand-held device (100d), a home appliance (100e), an Internet of Things (IoT) device (100f), and an Artificial Intelligence (AI) device/server (400). For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, and so on. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device (200a) may operate as a BS/network node with respect to other wireless devices.

The wireless devices (100a-100f) may be connected to the network (300) via the BSs (200). An AI technology may be applied to the wireless devices (100a-100f) and the wireless devices (100a-100f) may be connected to the AI server (400) via the network (300). The network (300) may be configured using a 3G network, a 4G (e.g., LTE) network, or a 5G (e.g., NR) network. Although the wireless devices (100a-100f) may communicate with each other through the BSs (200)/network (300), the wireless devices (100a-100f) may perform direct communication (e.g., sidelink communication) with each other without passing through the BSs/network. For example, the vehicles (100b-1, 100b-2) may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices (100a-1000.

Wireless communication/connections (150a, 150b, 150c) may be established between the wireless devices (100a-1000/BS (200), or BS (200)/BS (200). Herein, the wireless communication/connections may be established through various RATs (e.g., 5G NR) such as uplink/downlink communication (150a), sidelink communication (150b) (or, D2D communication), or inter BS communication (e.g. relay, Integrated Access Backhaul (IAB)). The wireless devices and the BSs/the wireless devices may transmit/receive radio signals to/from each other through the wireless communication/connections (150a, 150b). For example, the wireless communication/connections (150a, 150b) may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

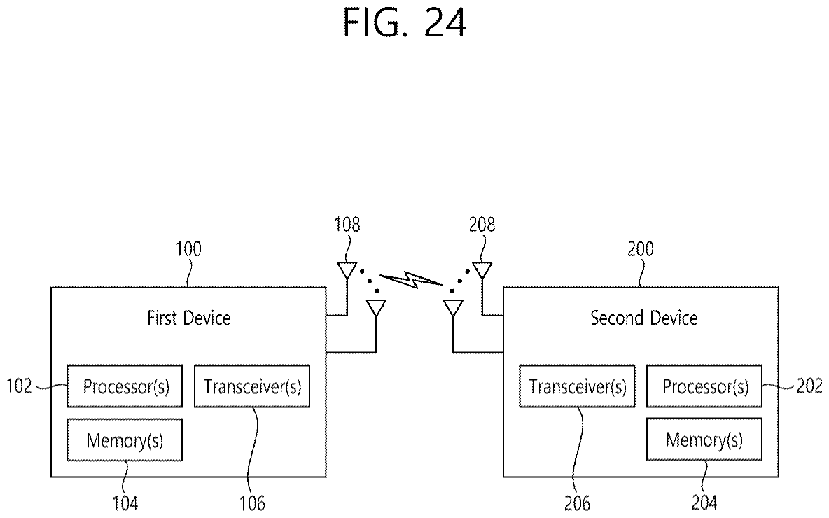

FIG. 24 shows wireless devices, in accordance with an embodiment of the present disclosure.

Referring to FIG. 24, a first wireless device (100) and a second wireless device (200) may transmit radio signals through a variety of RATs (e.g., LTE and NR). Herein, {the first wireless device (100) and the second wireless device (200)} may correspond to {the wireless device (100x), the BS (200)} and/or {the wireless device (100x), the wireless device (100x)} of FIG. 23.

The first wireless device (100) may include one or more processors (102) and one or more memories (104) and additionally further include one or more transceivers (106) and/or one or more antennas (108). The processor(s) (102) may control the memory(s) (104) and/or the transceiver(s) (106) and may be configured to implement the descriptions, functions, procedures, proposals, methods, and/or operational flowcharts disclosed in this document. For example, the processor(s) (102) may process information within the memory(s) (104) to generate first information/signals and then transmit radio signals including the first information/signals through the transceiver(s) (106). The processor(s) (102) may receive radio signals including second information/signals through the transceiver (106) and then store information obtained by processing the second information/signals in the memory(s) (104). The memory(s) (104) may be connected to the processor(s) (102) and may store a variety of information related to operations of the processor(s) (102). For example, the memory(s) (104) may store software code including commands for performing a part or the entirety of processes controlled by the processor(s) (102) or for performing the descriptions, functions, procedures, proposals, methods, and/or operational flowcharts disclosed in this document. Herein, the processor(s) (102) and the memory(s) (104) may be a part of a communication modem/circuit/chip designed to implement RAT (e.g., LTE or NR). The transceiver(s) (106) may be connected to the processor(s) (102) and transmit and/or receive radio signals through one or more antennas (108). Each of the transceiver(s) (106) may include a transmitter and/or a receiver. The transceiver(s) (106) may be interchangeably used with Radio Frequency (RF) unit(s). In the present disclosure, the wireless device may represent a communication modem/circuit/chip.

The second wireless device (200) may include one or more processors (202) and one or more memories (204) and additionally further include one or more transceivers (206) and/or one or more antennas (208). The processor(s) (202) may control the memory(s) (204) and/or the transceiver(s) (206) and may be configured to implement the descriptions, functions, procedures, proposals, methods, and/or operational flowcharts disclosed in this document. For example, the processor(s) (202) may process information within the memory(s) (204) to generate third information/signals and then transmit radio signals including the third information/signals through the transceiver(s) (206). The processor(s) (202) may receive radio signals including fourth information/signals through the transceiver(s) (106) and then store information obtained by processing the fourth information/signals in the memory(s) (204). The memory(s) (204) may be connected to the processor(s) (202) and may store a variety of information related to operations of the processor(s) (202). For example, the memory(s) (204) may store software code including commands for performing a part or the entirety of processes controlled by the processor(s) (202) or for performing the descriptions, functions, procedures, proposals, methods, and/or operational flowcharts disclosed in this document. Herein, the processor(s) (202) and the memory(s) (204) may be a part of a communication modem/circuit/chip designed to implement RAT (e.g., LTE or NR). The transceiver(s) (206) may be connected to the processor(s) (202) and transmit and/or receive radio signals through one or more antennas (208). Each of the transceiver(s) (206) may include a transmitter and/or a receiver. The transceiver(s) (206) may be interchangeably used with RF unit(s). In the present disclosure, the wireless device may represent a communication modem/circuit/chip.

Hereinafter, hardware elements of the wireless devices (100, 200) will be described more specifically. One or more protocol layers may be implemented by, without being limited to, one or more processors (102, 202). For example, the one or more processors (102, 202) may implement one or more layers (e.g., functional layers such as PHY, MAC, RLC, PDCP, RRC, and SDAP). The one or more processors (102, 202) may generate one or more Protocol Data Units (PDUs) and/or one or more Service Data Unit (SDUs) according to the descriptions, functions, procedures, proposals, methods, and/or operational flowcharts disclosed in this document. The one or more processors (102, 202) may generate messages, control information, data, or information according to the descriptions, functions, procedures, proposals, methods, and/or operational flowcharts disclosed in this document. The one or more processors (102, 202) may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers (106, 206). The one or more processors (102, 202) may receive the signals (e.g., baseband signals) from the one or more transceivers (106, 206) and obtain the PDUs, SDUs, messages, control information, data, or information according to the descriptions, functions, procedures, proposals, methods, and/or operational flowcharts disclosed in this document.

The one or more processors (102, 202) may be referred to as controllers, microcontrollers, microprocessors, or microcomputers. The one or more processors (102, 202) may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors (102, 202). The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors (102, 202) or stored in the one or more memories (104, 204) so as to be driven by the one or more processors (102, 202). The descriptions, functions, procedures, proposals, methods, and/or operational flowcharts disclosed in this document may be implemented using firmware or software in the form of code, commands, and/or a set of commands.

The one or more memories (104, 204) may be connected to the one or more processors (102, 202) and store various types of data, signals, messages, information, programs, code, instructions, and/or commands. The one or more memories (104, 204) may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories (104, 204) may be located at the interior and/or exterior of the one or more processors (102, 202). The one or more memories (104, 204) may be connected to the one or more processors (102, 202) through various technologies such as wired or wireless connection.

The one or more transceivers (106, 206) may transmit user data, control information, and/or radio signals/channels, mentioned in the methods and/or operational flowcharts of this document, to one or more other devices. The one or more transceivers (106, 206) may receive user data, control information, and/or radio signals/channels, mentioned in the descriptions, functions, procedures, proposals, methods, and/or operational flowcharts disclosed in this document, from one or more other devices. For example, the one or more transceivers (106, 206) may be connected to the one or more processors (102, 202) and transmit and receive radio signals. For example, the one or more processors (102, 202) may perform control so that the one or more transceivers (106, 206) may transmit user data, control information, or radio signals to one or more other devices. The one or more processors (102, 202) may perform control so that the one or more transceivers (106, 206) may receive user data, control information, or radio signals from one or more other devices. The one or more transceivers (106, 206) may be connected to the one or more antennas (108, 208) and the one or more transceivers (106, 206) may be configured to transmit and receive user data, control information, and/or radio signals/channels, mentioned in the descriptions, functions, procedures, proposals, methods, and/or operational flowcharts disclosed in this document, through the one or more antennas (108, 208). In this document, the one or more antennas may be a plurality of physical antennas or a plurality of logical antennas (e.g., antenna ports). The one or more transceivers (106, 206) may convert received radio signals/channels, and so on, from RF band signals into baseband signals in order to process received user data, control information, radio signals/channels, and so on, using the one or more processors (102, 202). The one or more transceivers (106, 206) may convert the user data, control information, radio signals/channels, and so on, processed using the one or more processors (102, 202) from the base band signals into the RF band signals. To this end, the one or more transceivers (106, 206) may include (analog) oscillators and/or filters.

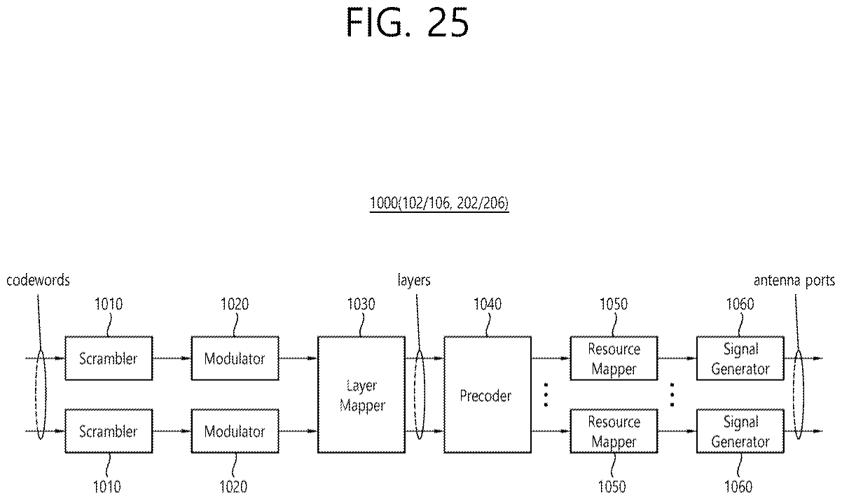

FIG. 25 shows a signal process circuit for a transmission signal, in accordance with an embodiment of the present disclosure.

Referring to FIG. 25, a signal processing circuit (1000) may include scramblers (1010), modulators (1020), a layer mapper (1030), a precoder (1040), resource mappers (1050), and signal generators (1060). An operation/function of FIG. 25 may be performed, without being limited to, the processors (102, 202) and/or the transceivers (106, 206) of FIG. 24. Hardware elements of FIG. 25 may be implemented by the processors (102, 202) and/or the transceivers (106, 206) of FIG. 24. For example, blocks 1010˜1060 may be implemented by the processors (102, 202) of FIG. 24. Alternatively, the blocks 1010˜1050 may be implemented by the processors (102, 202) of FIG. 24 and the block 1060 may be implemented by the transceivers (106, 206) of FIG. 24.

Codewords may be converted into radio signals via the signal processing circuit (1000) of FIG. 25. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers (1010). Scramble sequences used for scrambling may be generated based on an initialization value, and the initialization value may include ID information of a wireless device. The scrambled bit sequences may be modulated to modulation symbol sequences by the modulators (1020). A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper (1030). Modulation symbols of each transport layer may be mapped (precoded) to corresponding antenna port(s) by the precoder (1040). Outputs z of the precoder (1040) may be obtained by multiplying outputs y of the layer mapper (1030) by an N*M precoding matrix W. Herein, N is the number of antenna ports and M is the number of transport layers. The precoder (1040) may perform precoding after performing transform precoding (e.g., DFT) for complex modulation symbols. Alternatively, the precoder (1040) may perform precoding without performing transform precoding.

The resource mappers (1050) may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators (1060) may generate radio signals from the mapped modulation symbols and the generated radio signals may be transmitted to other devices through each antenna. For this purpose, the signal generators (1060) may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures (1010˜1060) of FIG. 25. For example, the wireless devices (e.g., 100, 200 of FIG. 24) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

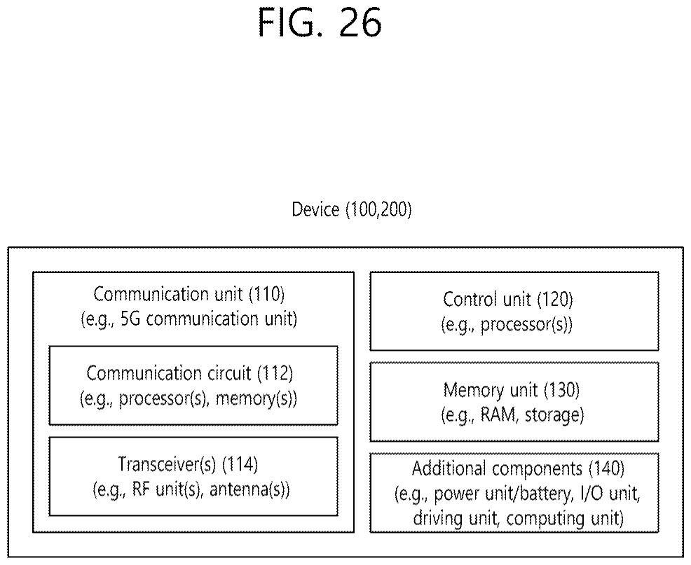

FIG. 26 shows another example of a wireless device, in accordance with an embodiment of the present disclosure. The wireless device may be implemented in various forms according to a use-case/service (refer to FIG. 23).

Referring to FIG. 26, wireless devices (100, 200) may correspond to the wireless devices (100, 200) of FIG. 24 and may be configured by various elements, components, units/portions, and/or modules. For example, each of the wireless devices (100, 200) may include a communication unit (110), a control unit (120), a memory unit (130), and additional components (140). The communication unit may include a communication circuit (112) and transceiver(s) (114). For example, the communication circuit (112) may include the one or more processors (102, 202) and/or the one or more memories (104, 204) of FIG. 24. For example, the transceiver(s) (114) may include the one or more transceivers (106, 206) and/or the one or more antennas (108, 208) of FIG. 24. The control unit (120) is electrically connected to the communication unit (110), the memory (130), and the additional components (140) and controls overall operation of the wireless devices. For example, the control unit (120) may control an electric/mechanical operation of the wireless device based on programs/code/commands/information stored in the memory unit (130). The control unit (120) may transmit the information stored in the memory unit (130) to the exterior (e.g., other communication devices) via the communication unit (110) through a wireless/wired interface or store, in the memory unit (130), information received through the wireless/wired interface from the exterior (e.g., other communication devices) via the communication unit (110).

The additional components (140) may be variously configured according to types of wireless devices. For example, the additional components (140) may include at least one of a power unit/battery, input/output (I/O) unit, a driving unit, and a computing unit. The wireless device may be implemented in the form of, without being limited to, the robot (100a of FIG. 23), the vehicles (100b-1, 100b-2 of FIG. 23), the XR device (100c of FIG. 23), the hand-held device (100d of FIG. 23), the home appliance (100e of FIG. 23), the IoT device (100f of FIG. 23), a digital broadcast terminal, a hologram device, a public safety device, an MTC device, a medicine device, a fintech device (or a finance device), a security device, a climate/environment device, the AI server/device (400 of FIG. 23), the BSs (200 of FIG. 23), a network node, and so on. The wireless device may be used in a mobile or fixed place according to a use-example/service.

In FIG. 26, the entirety of the various elements, components, units/portions, and/or modules in the wireless devices (100, 200) may be connected to each other through a wired interface or at least a part thereof may be wirelessly connected through the communication unit (110). For example, in each of the wireless devices (100, 200), the control unit (120) and the communication unit (110) may be connected by wire and the control unit (120) and first units (e.g., 130, 140) may be wirelessly connected through the communication unit (110). Each element, component, unit/portion, and/or module within the wireless devices (100, 200) may further include one or more elements. For example, the control unit (120) may be configured by a set of one or more processors. As an example, the control unit (120) may be configured by a set of a communication control processor, an application processor, an Electronic Control Unit (ECU), a graphical processing unit, and a memory control processor. As another example, the memory (130) may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 26 will be described in detail with reference to the drawings.

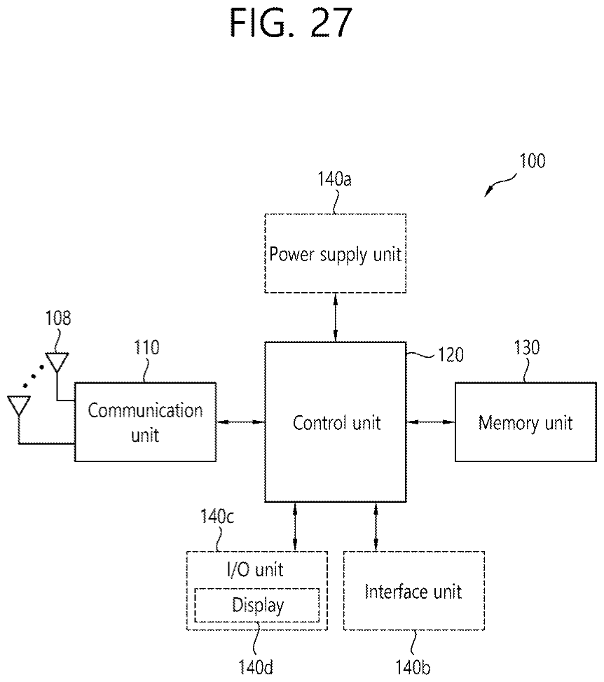

FIG. 27 shows a hand-held device, in accordance with an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 27, a hand-held device (100) may include an antenna unit (108), a communication unit (110), a control unit (120), a memory unit (130), a power supply unit (140a), an interface unit (140b), and an I/O unit (140c). The antenna unit (108) may be configured as a part of the communication unit (110). Blocks 110˜130/140a˜140c correspond to the blocks 110˜130/140 of FIG. 26, respectively.

The communication unit (110) may transmit and receive signals (e.g., data and control signals) to and from other wireless devices or BSs. The control unit (120) may perform various operations by controlling constituent elements of the hand-held device (100). The control unit (120) may include an Application Processor (AP). The memory unit (130) may store data/parameters/programs/code/commands needed to drive the hand-held device (100). The memory unit (130) may store input/output data/information. The power supply unit (140a) may supply power to the hand-held device (100) and include a wired/wireless charging circuit, a battery, and so on. The interface unit (140b) may support connection of the hand-held device (100) to other external devices. The interface unit (140b) may include various ports (e.g., an audio I/O port and a video I/O port) for connection with external devices. The I/O unit (140c) may input or output video information/signals, audio information/signals, data, and/or information input by a user. The I/O unit (140c) may include a camera, a microphone, a user input unit, a display unit (140d), a speaker, and/or a haptic module.

As an example, in the case of data communication, the I/O unit (140c) may obtain information/signals (e.g., touch, text, voice, images, or video) input by a user and the obtained information/signals may be stored in the memory unit (130). The communication unit (110) may convert the information/signals stored in the memory into radio signals and transmit the converted radio signals to other wireless devices directly or to a BS. The communication unit (110) may receive radio signals from other wireless devices or the BS and then restore the received radio signals into original information/signals. The restored information/signals may be stored in the memory unit (130) and may be output as various types (e.g., text, voice, images, video, or haptic) through the I/O unit (140c).

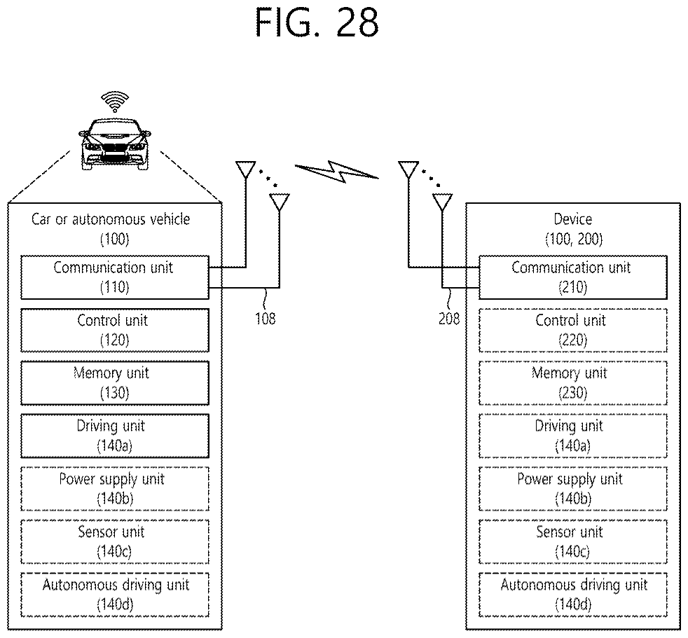

FIG. 28 shows a vehicle or an autonomous vehicle, in accordance with an embodiment of the present disclosure. The vehicle or autonomous vehicle may be implemented by a mobile robot, a car, a train, a manned/unmanned Aerial Vehicle (AV), a ship, and so on.

Referring to FIG. 28, a vehicle or autonomous vehicle (100) may include an antenna unit (108), a communication unit (110), a control unit (120), a driving unit (140a), a power supply unit (140b), a sensor unit (140c), and an autonomous driving unit (140d). The antenna unit (108) may be configured as a part of the communication unit (110). The blocks 110/130/140a˜140d correspond to the blocks 110/130/140 of FIG. 26, respectively.

The communication unit (110) may transmit and receive signals (e.g., data and control signals) to and from external devices such as other vehicles, BSs (e.g., gNBs and road side units), and servers. The control unit (120) may perform various operations by controlling elements of the vehicle or the autonomous vehicle (100). The control unit (120) may include an Electronic Control Unit (ECU). The driving unit (140a) may cause the vehicle or the autonomous vehicle (100) to drive on a road. The driving unit (140a) may include an engine, a motor, a powertrain, a wheel, a brake, a steering device, and so on. The power supply unit (140b) may supply power to the vehicle or the autonomous vehicle (100) and include a wired/wireless charging circuit, a battery, and so on. The sensor unit (140c) may obtain a vehicle state, ambient environment information, user information, and so on. The sensor unit (140c) may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit (140d) may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit (110) may receive map data, traffic information data, and so on, from an external server. The autonomous driving unit (140d) may generate an autonomous driving path and a driving plan from the obtained data. The control unit (120) may control the driving unit (140a) such that the vehicle or the autonomous vehicle (100) may move along the autonomous driving path according to the driving plan (e.g., speed/direction control). In the middle of autonomous driving, the communication unit (110) may aperiodically/periodically obtain recent traffic information data from the external server and obtain surrounding traffic information data from neighboring vehicles. In the middle of autonomous driving, the sensor unit (140c) may obtain a vehicle state and/or surrounding environment information. The autonomous driving unit (140d) may update the autonomous driving path and the driving plan based on the newly obtained data/information. The communication unit (110) may transfer information on a vehicle position, the autonomous driving path, and/or the driving plan to the external server. The external server may predict traffic information data using AI technology, and so on, based on the information collected from vehicles or autonomous vehicles and provide the predicted traffic information data to the vehicles or the autonomous vehicles.

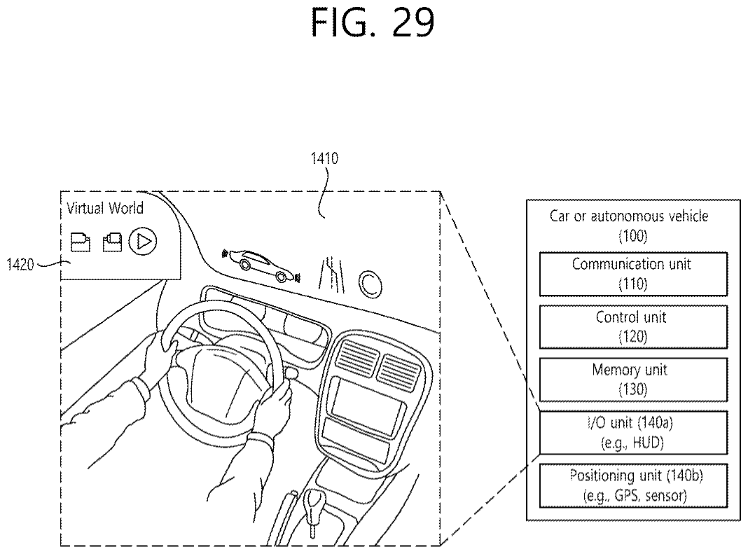

FIG. 29 shows a vehicle, in accordance with an embodiment of the present disclosure. The vehicle may be implemented as a transport means, an aerial vehicle, a ship, and so on.

Referring to FIG. 29, a vehicle (100) may include a communication unit (110), a control unit (120), a memory unit (130), an I/O unit (140a), and a positioning unit (140b). Herein, the blocks 110˜130/140a˜140b correspond to blocks 110˜130/140 of FIG. 26.

The communication unit (110) may transmit and receive signals (e.g., data and control signals) to and from external devices such as other vehicles or BSs. The control unit (120) may perform various operations by controlling constituent elements of the vehicle (100). The memory unit (130) may store data/parameters/programs/code/commands for supporting various functions of the vehicle (100). The I/O unit (140a) may output an AR/VR object based on information within the memory unit (130). The I/O unit (140a) may include an HUD. The positioning unit (140b) may obtain information on the position of the vehicle (100). The position information may include information on an absolute position of the vehicle (100), information on the position of the vehicle (100) within a traveling lane, acceleration information, and information on the position of the vehicle (100) from a neighboring vehicle. The positioning unit (140b) may include a GPS and various sensors.

As an example, the communication unit (110) of the vehicle (100) may receive map information and traffic information from an external server and store the received information in the memory unit (130). The positioning unit (140b) may obtain the vehicle position information through the GPS and various sensors and store the obtained information in the memory unit (130). The control unit (120) may generate a virtual object based on the map information, traffic information, and vehicle position information and the I/O unit (140a) may display the generated virtual object in a window in the vehicle (1410, 1420). The control unit (120) may determine whether the vehicle (100) normally drives within a traveling lane, based on the vehicle position information. If the vehicle (100) abnormally exits from the traveling lane, the control unit (120) may display a warning on the window in the vehicle through the I/O unit (140a). In addition, the control unit (120) may broadcast a warning message regarding driving abnormity to neighboring vehicles through the communication unit (110). According to situation, the control unit (120) may transmit the vehicle position information and the information on driving/vehicle abnormality to related organizations.

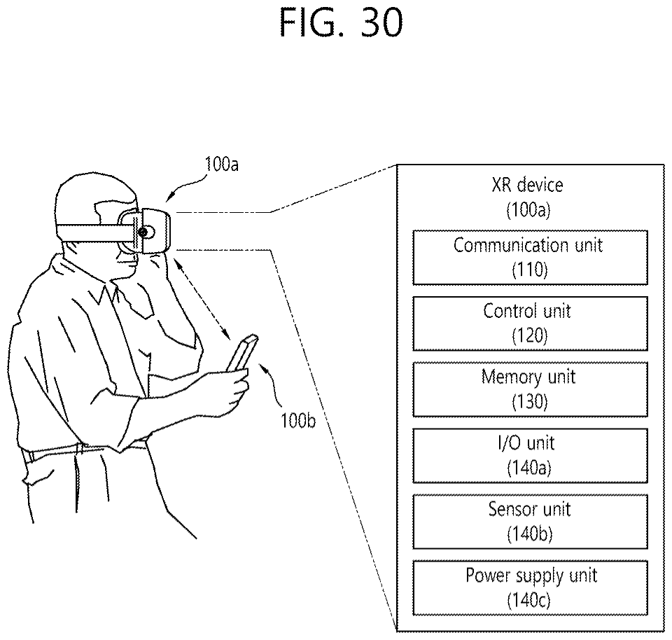

FIG. 30 shows an XR device, in accordance with an embodiment of the present disclosure. The XR device may be implemented by an HMD, an HUD mounted in a vehicle, a television, a smartphone, a computer, a wearable device, a home appliance, a digital signage, a vehicle, a robot, and so on.

Referring to FIG. 30, an XR device (100a) may include a communication unit (110), a control unit (120), a memory unit (130), an I/O unit (140a), a sensor unit (140b), and a power supply unit (140c). Herein, the blocks 110˜130/140a˜140c correspond to the blocks 110˜130/140 of FIG. 26, respectively.

The communication unit (110) may transmit and receive signals (e.g., media data and control signals) to and from external devices such as other wireless devices, hand-held devices, or media servers. The media data may include video, images, and sound. The control unit (120) may perform various operations by controlling constituent elements of the XR device (100a). For example, the control unit (120) may be configured to control and/or perform procedures such as video/image acquisition, (video/image) encoding, and metadata generation and processing. The memory unit (130) may store data/parameters/programs/code/commands needed to drive the XR device (100a)/generate XR object. The I/O unit (140a) may obtain control information and data from the exterior and output the generated XR object. The I/O unit (140a) may include a camera, a microphone, a user input unit, a display unit, a speaker, and/or a haptic module. The sensor unit (140b) may obtain an XR device state, surrounding environment information, user information, and so on. The sensor unit (140b) may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit (140c) may supply power to the XR device (100a) and include a wired/wireless charging circuit, a battery, and so on.

For example, the memory unit (130) of the XR device (100a) may include information (e.g., data) needed to generate the XR object (e.g., an AR/VR/MR object). The I/O unit (140a) may receive a command for manipulating the XR device (100a) from a user and the control unit (120) may drive the XR device (100a) according to a driving command of a user. For example, when a user desires to watch a film or news through the XR device (100a), the control unit (120) transmits content request information to another device (e.g., a hand-held device 100b) or a media server through the communication unit (130). The communication unit (130) may download/stream content such as films or news from another device (e.g., the hand-held device 100b) or the media server to the memory unit (130). The control unit (120) may control and/or perform procedures such as video/image acquisition, (video/image) encoding, and metadata generation/processing with respect to the content and generate/output the XR object based on information on a surrounding space or a real object obtained through the I/O unit (140a)/sensor unit (140b).

The XR device (100a) may be wirelessly connected to the hand-held device (100b) through the communication unit (110) and the operation of the XR device (100a) may be controlled by the hand-held device (100b). For example, the hand-held device (100b) may operate as a controller of the XR device (100a). To this end, the XR device (100a) may obtain information on a 3D position of the hand-held device (100b) and generate and output an XR object corresponding to the hand-held device (100b).

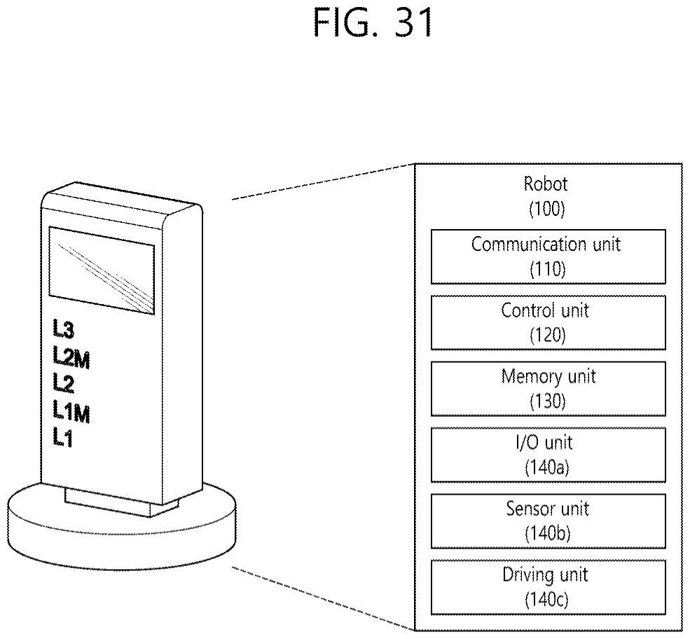

FIG. 31 shows a robot, in accordance with an embodiment of the present disclosure. The robot may be categorized into an industrial robot, a medical robot, a household robot, a military robot, and so on, according to a used purpose or field.

Referring to FIG. 31, a robot (100) may include a communication unit (110), a control unit (120), a memory unit (130), an I/O unit (140a), a sensor unit (140b), and a driving unit (140c). Herein, the blocks 110˜130/140a˜140c correspond to the blocks 110˜130/140 of FIG. 26, respectively.

The communication unit (110) may transmit and receive signals (e.g., driving information and control signals) to and from external devices such as other wireless devices, other robots, or control servers. The control unit (120) may perform various operations by controlling constituent elements of the robot (100). The memory unit (130) may store data/parameters/programs/code/commands for supporting various functions of the robot (100). The I/O unit (140a) may obtain information from the exterior of the robot (100) and output information to the exterior of the robot (100). The I/O unit (140a) may include a camera, a microphone, a user input unit, a display unit, a speaker, and/or a haptic module. The sensor unit (140b) may obtain internal information of the robot (100), surrounding environment information, user information, and so on. The sensor unit (140b) may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, and so on. The driving unit (140c) may perform various physical operations such as movement of robot joints. In addition, the driving unit (140c) may cause the robot (100) to travel on the road or to fly. The driving unit (140c) may include an actuator, a motor, a wheel, a brake, a propeller, and so on.

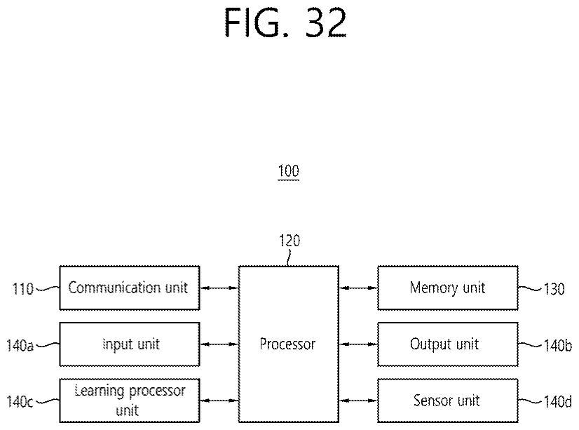

FIG. 32 shows an AI device, in accordance with an embodiment of the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, and so on.

Referring to FIG. 32, an AI device (100) may include a communication unit (110), a control unit (120), a memory unit (130), an I/O unit (140a/140b), a learning processor unit (140c), and a sensor unit (140d). The blocks 110˜130/140a˜140d correspond to blocks 110˜130/140 of FIG. 26, respectively.

The communication unit (110) may transmit and receive wired/radio signals (e.g., sensor information, user input, learning models, or control signals) to and from external devices such as other AI devices (e.g., 100x, 200, 400 of FIG. 23) or an AI server (e.g., 400 of FIG. 23) using wired/wireless communication technology. To this end, the communication unit (110) may transmit information within the memory unit (130) to an external device and transmit a signal received from the external device to the memory unit (130).

The control unit (120) may determine at least one feasible operation of the AI device (100), based on information which is determined or generated using a data analysis algorithm or a machine learning algorithm. The control unit (120) may perform an operation determined by controlling constituent elements of the AI device (100). For example, the control unit (120) may request, search, receive, or use data of the learning processor unit (140c) or the memory unit (130) and control the constituent elements of the AI device (100) to perform a predicted operation or an operation determined to be preferred among at least one feasible operation. The control unit (120) may collect history information including the operation contents of the AI device (100) and operation feedback by a user and store the collected information in the memory unit (130) or the learning processor unit (140c) or transmit the collected information to an external device such as an AI server (400 of FIG. 23). The collected history information may be used to update a learning model.

The memory unit (130) may store data for supporting various functions of the AI device (100). For example, the memory unit (130) may store data obtained from the input unit (140a), data obtained from the communication unit (110), output data of the learning processor unit (140c), and data obtained from the sensor unit (140). The memory unit (130) may store control information and/or software code needed to operate/drive the control unit (120).

The input unit (140a) may obtain various types of data from the exterior of the AI device (100). For example, the input unit (140a) may obtain learning data for model learning, and input data to which the learning model is to be applied. The input unit (140a) may include a camera, a microphone, and/or a user input unit. The output unit (140b) may generate output related to a visual, auditory, or tactile sense. The output unit (140b) may include a display unit, a speaker, and/or a haptic module. The sensing unit (140) may obtain at least one of internal information of the AI device (100), surrounding environment information of the AI device (100), and user information, using various sensors. The sensor unit (140) may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit (140c) may learn a model consisting of artificial neural networks, using learning data. The learning processor unit (140c) may perform AI processing together with the learning processor unit of the AI server (400 of FIG. 24). The learning processor unit (140c) may process information received from an external device through the communication unit (110) and/or information stored in the memory unit (130). In addition, an output value of the learning processor unit (140c) may be transmitted to the external device through the communication unit (110) and may be stored in the memory unit (130).

1. A method for managing a cluster, the method performed by a first terminal included in the cluster and comprising:
detecting mobility of a second terminal;
transmitting, to the second terminal, a cluster join message based on the second terminal satisfying a clustering condition; and
transmitting, to the second terminal, a cluster message,
wherein the cluster join message includes information for requesting to join the second terminal to the cluster, and
wherein the cluster message includes information related to the cluster.

2. The method of claim 1, wherein the mobility of the second terminal includes at least one of a speed of the second terminal, a moving direction of the second terminal, and a position of the second terminal.

3. The method of claim 1, wherein the clustering condition comprises at least one of a first condition in which a distance between the second terminal and the first terminal or a distance between the second terminal and a center position of the cluster is less than or equal to a distance threshold, a second condition in which a received power for a signal transmitted from the second terminal is equal to or greater than a power threshold, a third condition in which a speed difference with the first terminal or the cluster is less than or equal to a speed threshold, and a fourth condition in which a movement direction difference with the first terminal or the cluster is less than or equal to a movement direction threshold value.

4. The method of claim 3, wherein the received power is a reference signal received power (RSRP).

5. The method of claim 1, wherein the information related to the cluster includes information related to mobility of the cluster.

6. The method of claim 5, wherein the mobility of the cluster includes at least one of a speed of the cluster, a movement direction of the cluster, and a position of the cluster.

7. The method of claim 1, wherein the second terminal is included in the cluster based on the first terminal receiving a response message for the cluster join message from the second terminal.

8. The method of claim 1, wherein the first terminal detects the mobility of the second terminal based on the first terminal receiving a cluster join request message from the second terminal.

9. The method of claim 1, wherein the cluster includes a plurality of terminals,
wherein a difference between a speed of each of the plurality of terminals and an average speed of the cluster is less than or equal to a speed threshold,
wherein a difference between a moving direction of each of the plurality of terminals and an average moving direction of the cluster is less than or equal to a direction threshold, and
wherein the cluster has an area less than or equal to a coverage threshold.

10. The method of claim 1, wherein the cluster is a subscription cluster which is subscribed by the second terminal.

11. The method of claim 1, wherein the cluster message is a message transmitted periodically.

12. The method of claim 11, wherein, based on a terminal having a largest remaining battery capacity or a remaining data resource among a plurality of terminals included in the cluster being the first terminal, the first terminal periodically transmits the cluster message.

13. The method of claim 1, wherein the first terminal is a representative terminal of the cluster.

14. The method of claim 1, wherein the second terminal is a low-power terminal.

15. A first terminal included in a cluster, comprising:
at least one memory storing instructions;
at least one transceiver; and
at least one processor coupling the at least one memory and the at least one transceiver, wherein the at least one processor execute the instructions for:
detecting mobility of a second terminal;
transmitting, to the second terminal, a cluster join message based on the second terminal satisfying a clustering condition; and
transmitting, to the second terminal, a cluster message,
wherein the cluster join message includes information for requesting to join the second terminal to the cluster, and
wherein the cluster message includes information related to the cluster.

16. (canceled)

17. An apparatus configured to control a first terminal included in a cluster, the apparatus comprising:
at least one processor; and
at least one memory operably coupled by the at least one processor and storing instructions, wherein the at least one processor execute the instructions for:
detecting mobility of a second terminal;
transmitting, to the second terminal, a cluster join message based on the second terminal satisfying a clustering condition; and
transmitting, to the second terminal, a cluster message,
wherein the cluster join message includes information for requesting to join the second terminal to the cluster, and
wherein the cluster message includes information related to the cluster.

18. (canceled)
